(19) United States
(12) Patent Application Publication
(10) Pub. No.: US 2024/0135261 A1
(43) Pub. Date: Apr. 25, 2024

(54) METHODS AND SYSTEMS FOR CONSTRUCTING AN ONTOLOGY OF LOG MESSAGES WITH NAVIGATION AND KNOWLEDGE TRANSFER

(71) Applicant: VMware LLC, Palo Alto, CA (US)

(72) Inventors: Vedant Diwanji, Palo Alto, CA (US); Junyuan Lin, Bellevue, WA (US); Darren Brown, Seattle, WA (US)

(73) Assignee: VMware LLC, Palo Alto, CA (US)

(21) Appl. No.: 17/968,712

(22) Filed: Oct. 18, 2022

(51) Int. Cl. G06N 20/10; G06F 16/26

(52) U.S. Cl. CPC G06N 20/10; G06F 16/26

(57) ABSTRACT

Computer-implemented methods and systems described herein are directed to constructing a navigable tiered ontology that characterize how groups of log messages are distributed across products and applications that run on the platforms provided by the products. The ontology is constructed based on the products, applications, and event types of the log messages. The ontology represents how the log messages are distributed across the products. applications, and event types. The ontology is displayed as a navigable flow map in a graphical user interface of a display device

### TECHNICAL FIELD

Methods and systems described herein are directed to managing log messages generated in a distributed computing system.

### BACKGROUND

Electronic computing has evolved from primitive, vacuum-tube-based computer systems, initially developed during the 1940s, to modern electronic computing systems in which large numbers of multi-processor computer systems, such as server computers, workstations, and other individual computing systems are networked together with large-capacity data storage devices and other electronic devices to produce geographically distributed data centers. Data centers receive, store, process, distribute, and allow access to large amounts of data. Data centers are made possible by advances in computer networking, virtualization, distributed operating systems and applications, data-storage appliances, computer hardware, and software technologies.

Data centers now make up most of the computational and data storage resources used in cloud computing and cloud-based services. Businesses, governments, and other organizations now store and process data, execute applications, and offer services to customers in the cloud. For example, data centers have enabled organizations to rent processing power and data storage in separate software defined data centers (“SDDC”) that can be scaled to meet user demands. To aid system administrators and application owners with detection of performance problems with applications executing in data centers, various automated management tools have been developed to collect performance information. For example, a typical log management tool records log messages generated by various operating systems and programs executing in a data center. Each log message is an unstructured or semi-structured time-stamped message that records an event that occurred in the operation of an operating system, an application, a service, or computer hardware at a point in time. Other types of events recorded in log messages include I/O operations, alerts or warnings, errors, device start up and shut down, diagnostic and statistical information. With the aid of log management tools, sophisticated teams of software engineers try to determine root causes of hardware and software performance problems. However, this process can be prohibitively expensive because of the ever-increasing volumes of log messages that must be stored and processed. As a result, processing these large volumes of log messages to detect the root cause of a problem is error prone and can take weeks and, in some cases, longer. Long delays in detecting and correcting the root cause of a performance problem can create mistakes in processing transactions with customers or deny people access to vital services provided by an organization, which damages an organization's reputation and drives customers to competitors. System administrators and application owners seek computer-implemented log management tools that efficiently and timely aid with detection of performance issues.

### SUMMARY

Computer-implemented methods and systems described herein are directed to constructing a navigable tiered ontology that characterize how groups of log messages are distributed across products and applications that run on the platforms provided by the products. The ontology is constructed from the log messages recorded in a user selected time frame. The ontology is displayed in a user interface of display device as a flow map that enables users of various levels of expertise to see how the log messages are distributed across products, applications, and event types. The navigable flow map enables users to identify the log messages and event types that may be useful in resolving performance problems with applications.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers.

FIG. 13 shows an example of logging log messages in log files.

FIG. 14 shows an example source code of an event source.

FIG. 15 shows an example of a log write instruction.

FIG. 16 shows an example of a log message generated by the log write instruction in FIG. 15.

FIG. 17 shows a small, eight-entry portion of a log file.

FIG. 18 shows an example graph of products and applications of a system executing in a data center.

FIG. 19 shows a graph of products that serve as platforms for running applications in a data center.

FIG. 20 shows an example of a typical user interface of a log management tool.

FIG. 21 shows an example set of log messages with time stamps in a user selected time frame.

FIG. 22 shows a data pipeline for constructing a tiered ontology from a set of log messages, products, applications.

FIG. 23 shows a table of examples of regular expressions designed to match character strings of log messages.

FIG. 24 show an example of preprocessing and normalizing an example log message.

FIG. 25 shows a table of examples of primary Grok patterns and corresponding regular expressions.

FIG. 26 shows an example of a Grok expression constructed to extract tokens from a log message.

FIG. 27 shows an example of determining event-type distributions of event types generated in adjacent time windows of a time frame.

FIG. 28 shows a heatmap matrix of the event-type counts of the event types generated in a time frame.

FIG. 29 shows a portion of an example event-type heatmap.

FIG. 30 shows example heatmap plots for three different even types.

FIG. 31 shows a table of example event types and corresponding frequency classification stored in an event type database.

FIG. 32A shows a table of example tokens and corresponding word vectors stored in a word vector database.

FIG. 32B shows an example of word vectors and corresponding words in an embedding space.

FIG. 33 shows a process of embedding log messages in log vectors.

FIG. 34A shows an example of embedding four log messages into log vectors of a three-dimensional embedding space.

FIG. 34B shows an example plot of four log vectors.

FIG. 35 shows an example of an embedding space for log vectors of four applications and products.

FIG. 36A shows an example of log vectors in an embedding space.

FIG. 36B shows an example of a maximal margin hypersurface separating the log vectors shown in FIG. 36A.

FIGS. 37A-37D show examples of training four classification models that correspond to four products.

FIGS. 38A-38D show example plots of hypersurfaces that correspond to trained classification models obtained in corresponding FIGS. 37A-37D.

FIGS. 39A-39F show examples of training six classification models for six pairs of four products.

FIGS. 40A-40F show example plots of hypersurfaces that correspond to the trained classification models obtained in corresponding FIGS. 39A-39F.

FIG. 41A shows an example of a general three-tiered ontology for log messages obtained for a user-selected time frame.

FIG. 41B show an example of a three-tiered ontology for log messages associated with products executed in a data center.

FIGS. 42A-42E show a graphical user interface (“GUI”) for displaying a navigable flow map that represents an ontology of products, applications, and event types of log messages queried for a user-selected time frame.

FIG. 43 is a flow diagram of a method for constructing an ontology of products, applications, and events of log messages for a system running in a data center.

FIG. 44 is a flow diagram illustrating an example implementation of the “construct a tiered ontology based on the products, applications, and event types of the log messages” procedure performed in FIG. 43.

FIG. 45 is a flow diagram illustrating an example implementation of the “normalize the log message” procedure performed in FIG. 44.

FIG. 46 is a flow diagram illustrating an example implementation of the “generate a heatmap” procedure performed in FIG. 44.

FIG. 47 is a flow diagram illustrating an example implementation of the “preform frequency analysis” procedure performed in FIG. 44.

FIG. 48 is a flow diagram illustrating an example implementation of the “embed log messages into log vectors” procedure performed in FIG. 44.

### DETAILED DESCRIPTION

This disclosure is directed to computer-implemented methods and systems for constructing an ontology of products, applications, and events recorded in log messages for a system running in a data center. Computer hardware, complex computational systems and virtualization are described in a first subsection. Log messages and log files are described in a second subsection. Computer-implemented methods and systems for constructing an ontology are described in a third subsection.

### Computer Hardware, Complex Computation Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

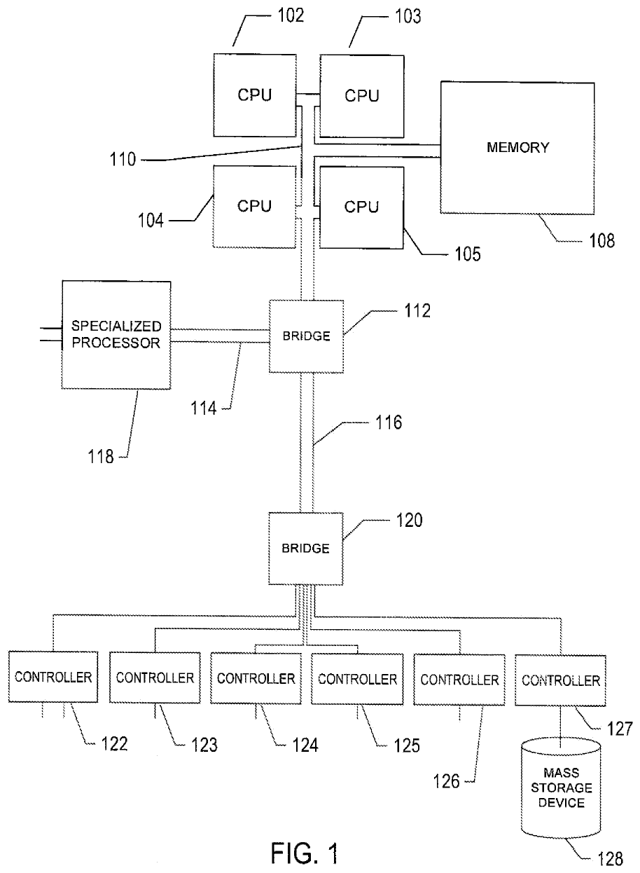

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

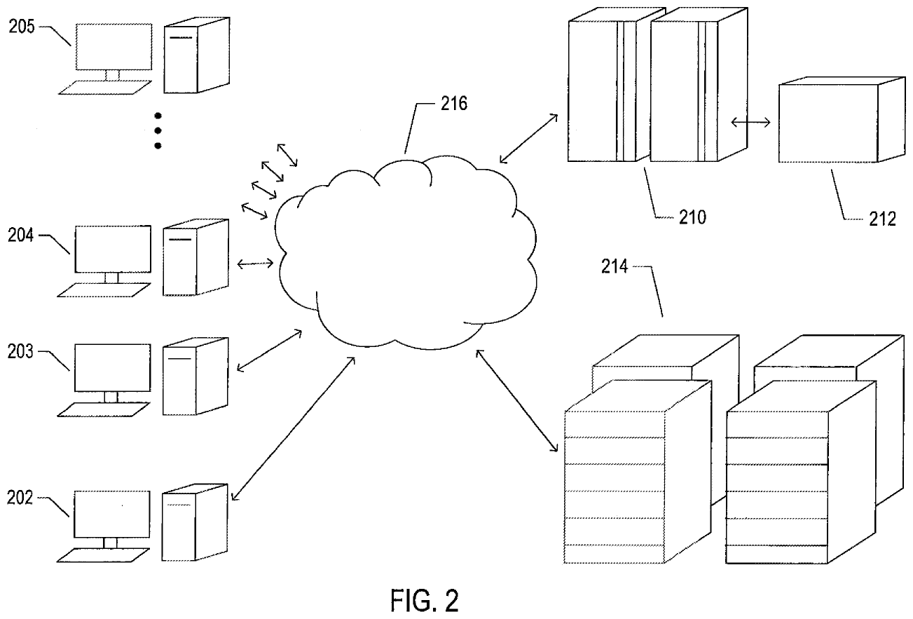

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

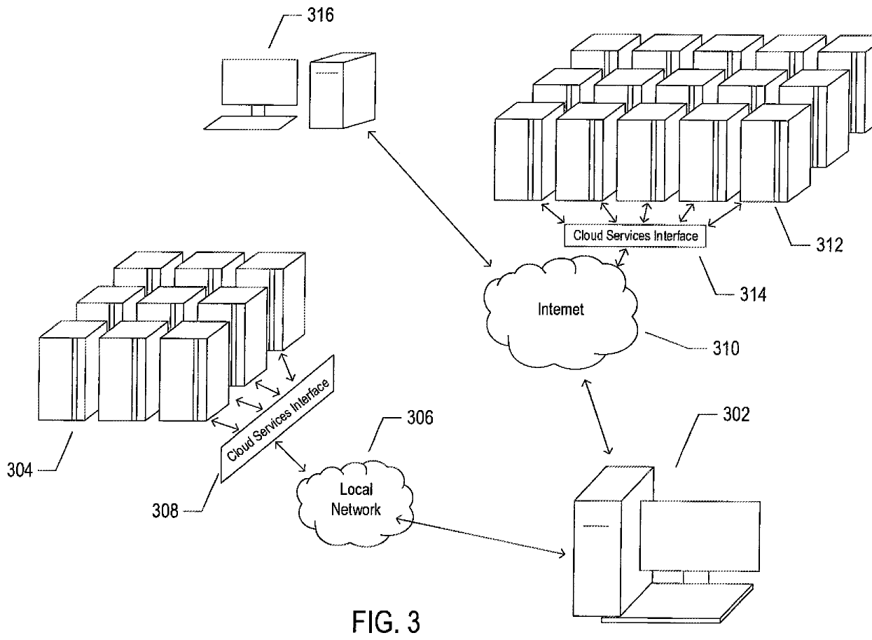

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of. subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

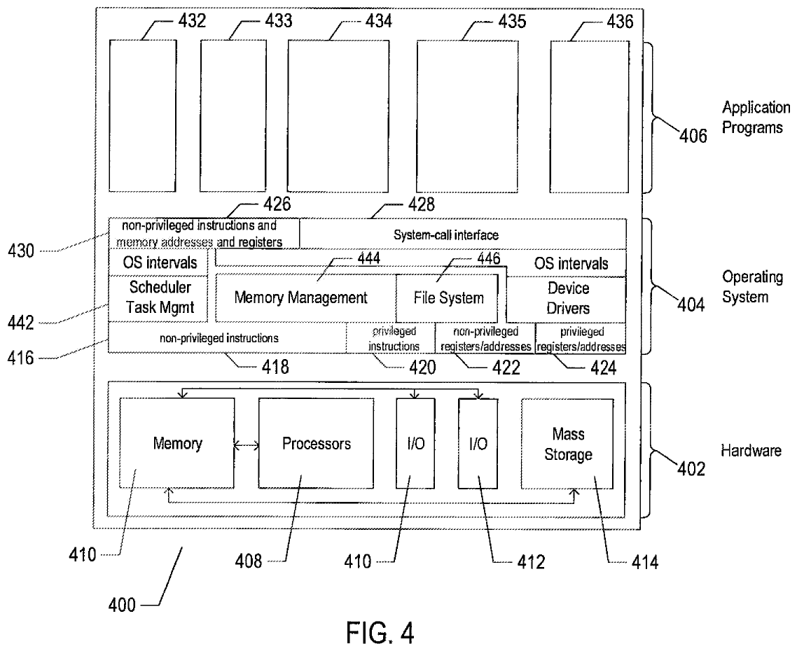

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree. modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, casy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

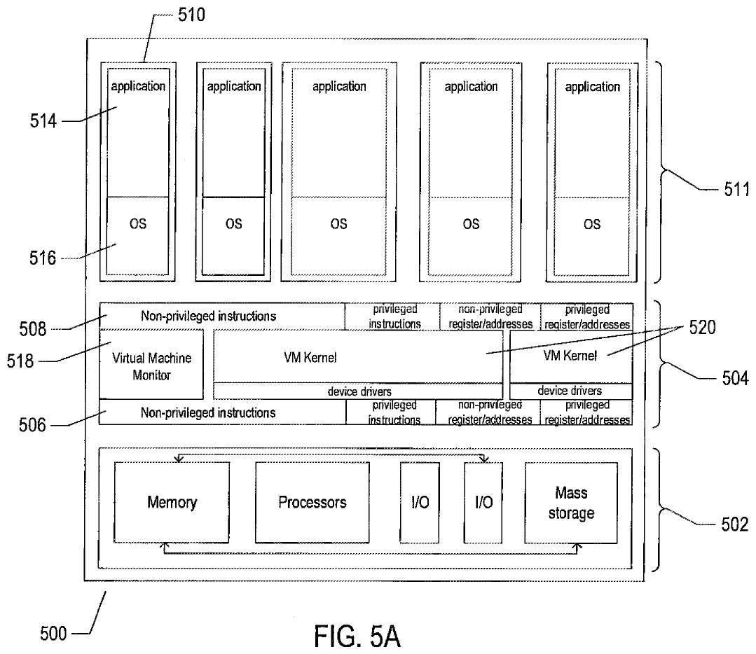

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system.” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

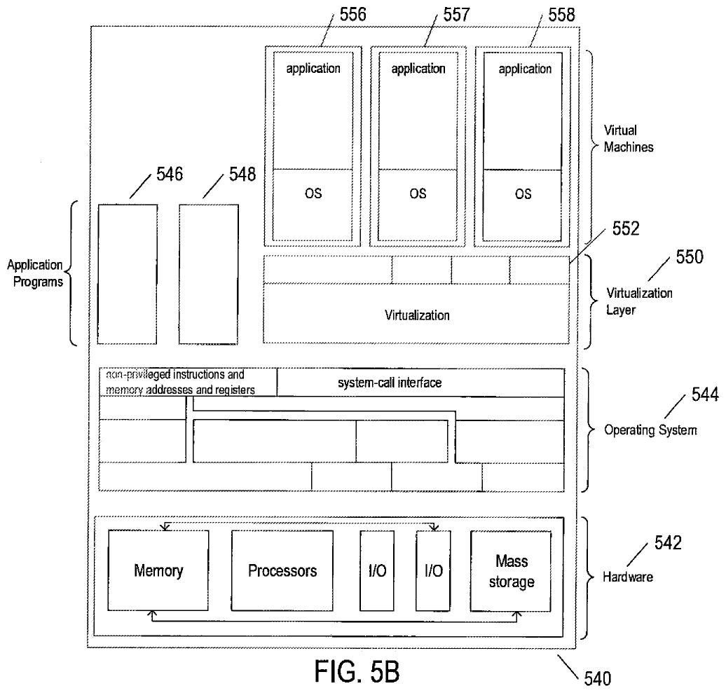

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608. one or more disk-image files 610-611, and one or more device files 612-614. The OVF package can be encoded and stored as a single file or as a set of files. The OVF descriptor 604 is an XML document 620 that includes a hierarchical set of clements, each demarcated by a beginning tag and an ending tag. The outermost, or highest-level, clement is the envelope element, demarcated by tags 622 and 623. The next-level clement includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and clements within a typical OVF descriptor. The OVF descriptor is thus a self-describing. XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

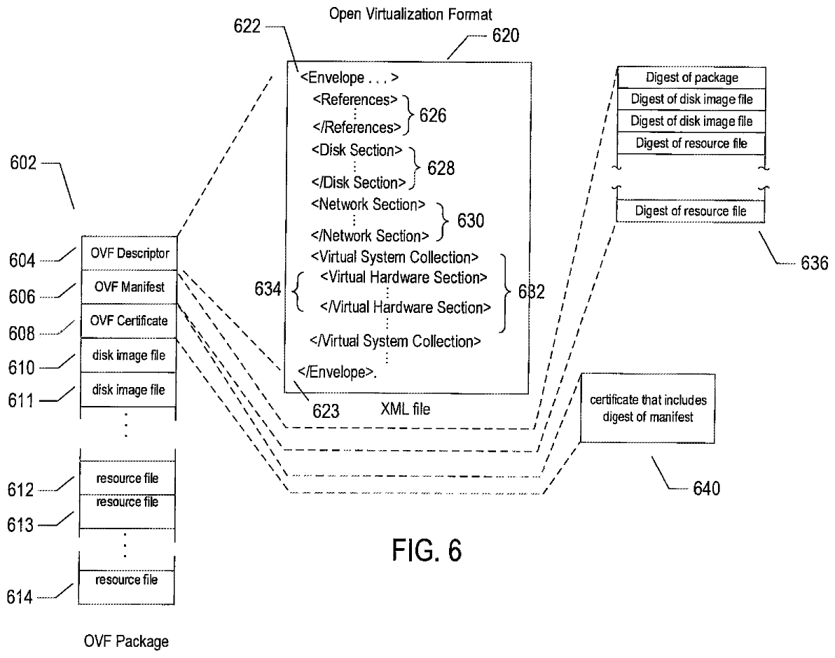

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation. provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

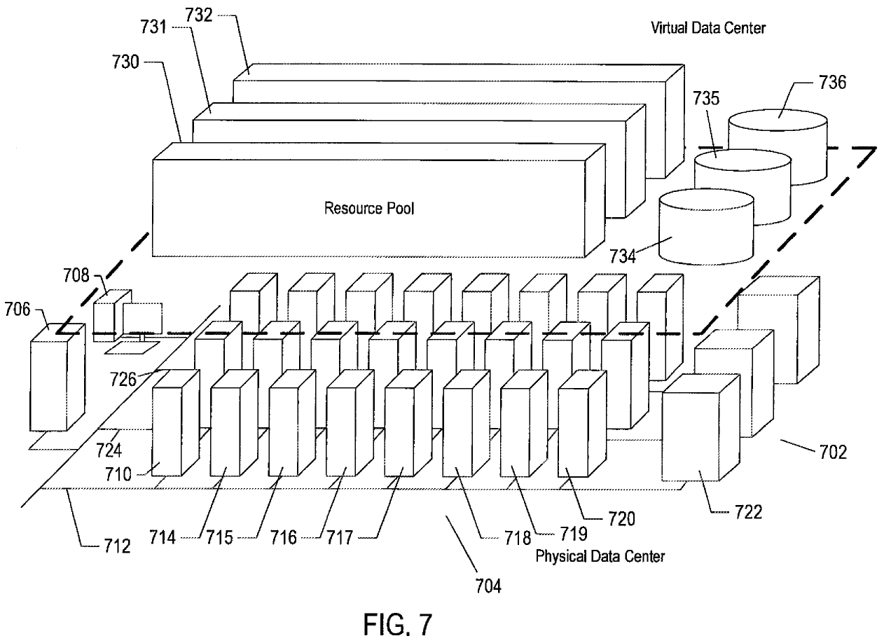

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

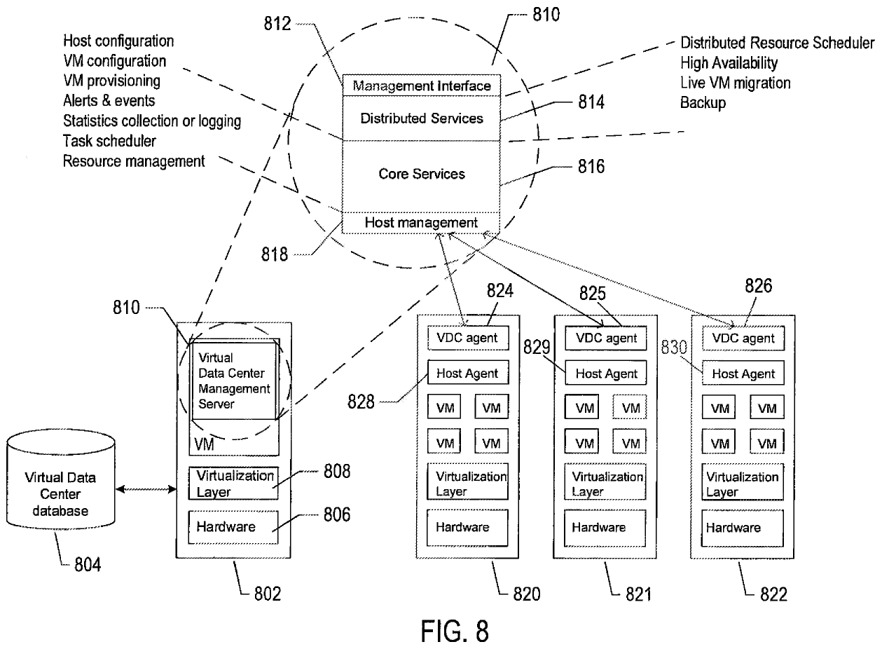

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS andfor one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

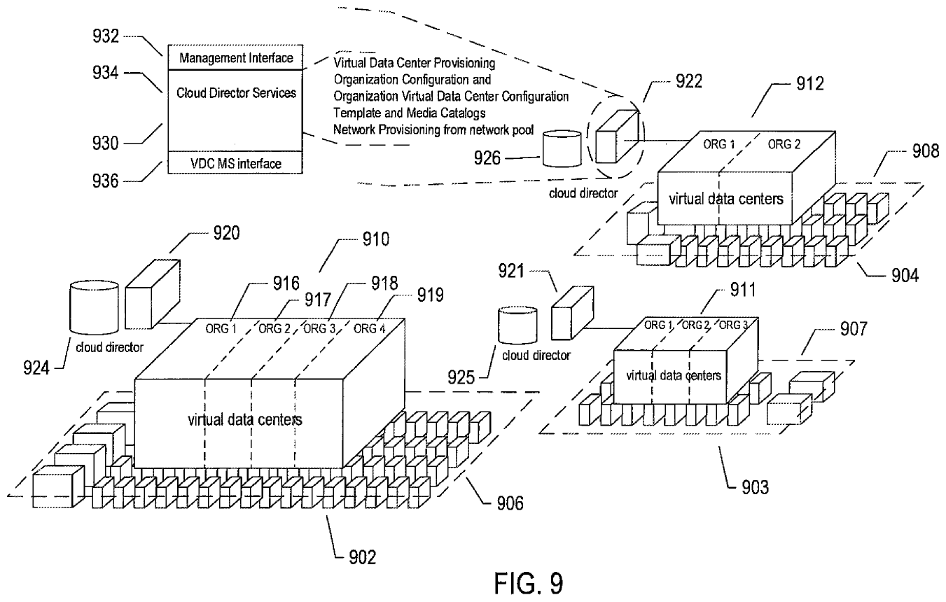

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate cach container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

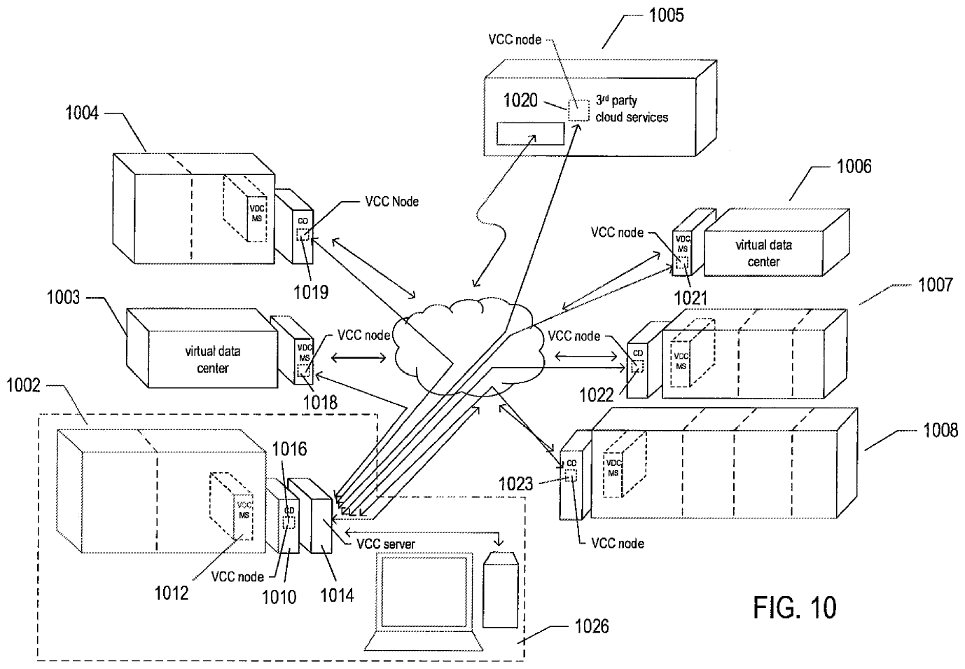

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to cach of the containers 1108-1110. The containers, in turn, provide an execution environment for an application that runs within the execution environment provided by container 1108. The container can be thought of as a partition of the resources generally available to higher-level computational entities through the operating system interface 430.

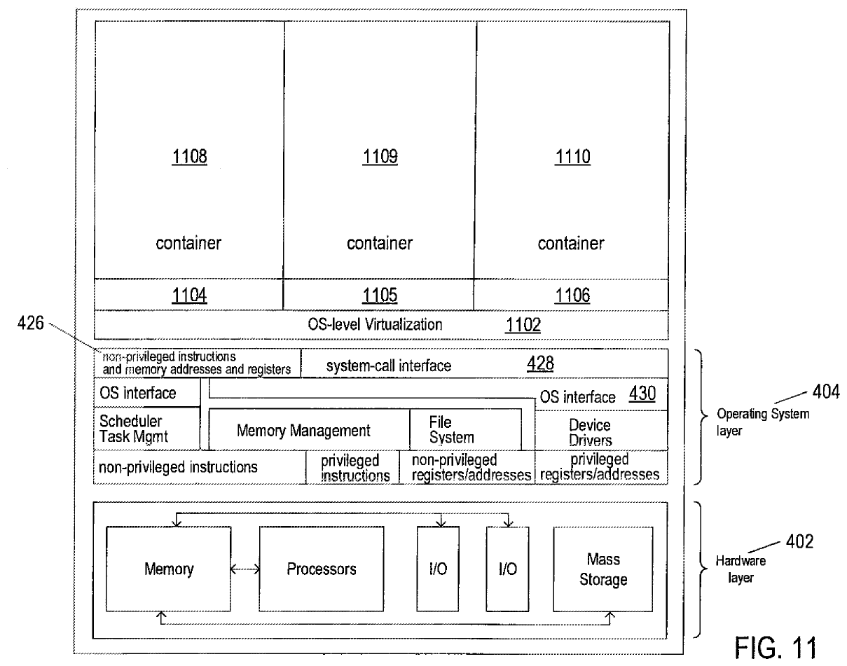

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling. and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Log Messages and Log Files

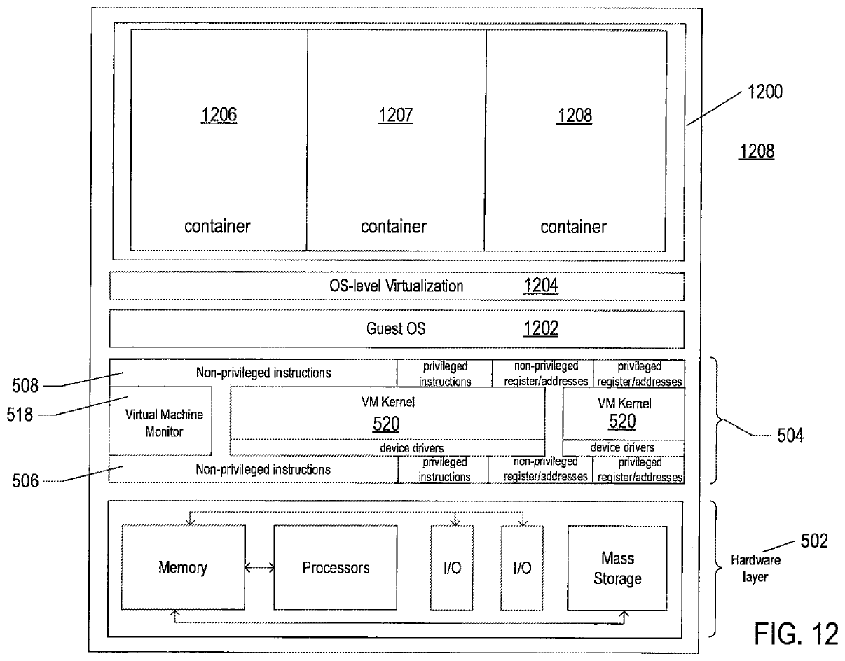

FIG. 13 shows an example of logging log messages in log files. In FIG. 13, computer systems 1302-1306 of a distributed computing system are linked together by an electronic communications medium 1308 and additionally linked through a communications bridge/router 1310 to an administration computer system 1312 that includes an administrative console 1314. Each of the computer systems 1302-1306 runs a log monitoring agent that forwards log messages to a log management server executing on the administration computer system 1312. As indicated by curved arrows, such as curved arrow 1316, multiple components within each of the discrete computer systems 1302-1306 as well as the communications bridge/router 1310 generate log messages that are forwarded to the log management server. Log messages may be generated by any event source. Event sources may be, but are not limited to, application programs, operating systems, VMs, guest operating systems, containers, network devices, machine codes, event channels, and other computer programs or processes running on the computer systems 1302-1306, the bridge/router 1310 and any other components of a data center. Log messages may be received by log monitoring agents at various hierarchical levels within a discrete computer system and then forwarded to the log management server executing in the administration computer system 1312. The log management server records the log messages in a data storage device or appliance 1318 as log files 1320-1324. Rectangles, such as rectangle 1326, represent individual log messages. For example, log file 320 may contain a list of log messages generated within the computer system 1302. Each log monitoring agent has a configuration that includes a log path and a log parser. The log path specifies a unique file system path in terms of a directory trec hierarchy that identifies the storage location of a log file on the administration computer system 1312 or the data storage device 1318. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 1312 and computer systems 1302-1306 may function without log monitoring agents and a log management server, but with less precision and certainty.

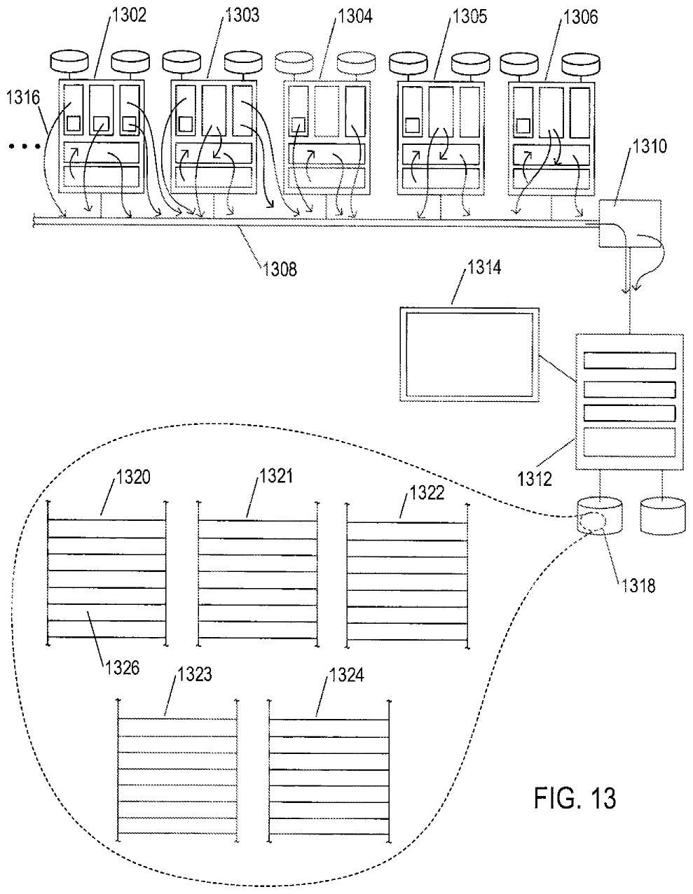

FIG. 14 shows an example source code 1402 of an event source, such as an application, an operating system, a VM, a guest operating system. or any other computer program or machine code that generates log messages. The source code 1402 is just one example of an event source that generates log messages. Rectangles, such as rectangle 1404, represent a definition, a comment, a statement, or a computer instruction that expresses some action to be executed by a computer. The source code 1402 includes log write instructions that generate log messages when certain events predetermined by a developer occur during execution of the source code 1402. For example, source code 1402 includes an example log write instruction 1406 that when executed generates a “log message 1” represented by rectangle 408, and a second example log write instruction 1410 that when executed generates “log message 2” represented by rectangle 1412. In the example of FIG. 14, the log write instruction 408 is embedded within a set of computer instructions that are repeatedly executed in a loop 1414. As shown in FIG. 4, the same log message 1 is repeatedly generated 1416. The same type of log write instructions may also be located in different places throughout the source code, which in turns creates repeats of essentially the same type of log message in the log file.

In FIG. 14, the notation “log.write( )” is a general representation of a log write instruction. In practice, the form of the log write instruction varies for different programming languages. In general. the log write instructions are determined by the developer and unstructured. or semi-structured, and relatively cryptic. For example, log write instructions may include instructions for time stamping the log message and contain a message comprising natural-language words andky phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program, operating system and version. server computer, and network device) and may include the name of the log file to which the log message is recorded. Log write instructions may be written in a source code by the developer of an application program or operating system in order to record the state of the application program or operating system at a point in time and to record events that occur while an operating system or application program is executing. For example, a developer may include log write instructions that record informative events including, but are not limited to, identifying startups, shutdowns. I/O operations of applications or devices; errors identifying runtime deviations from normal behavior or unexpected conditions of applications or non-responsive devices: fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages. and fatal log messages. Informative log messages are indicative of a normal or benign state of an event source.

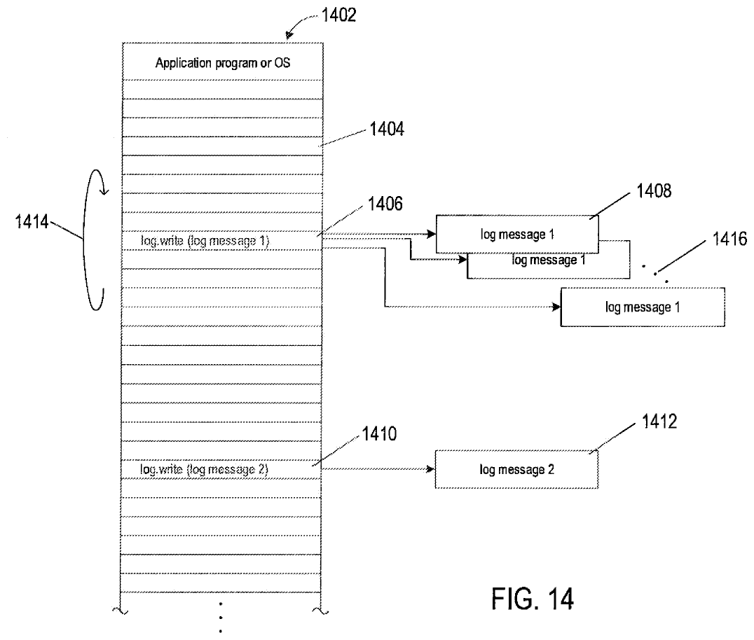

FIG. 15 shows an example of a log write instruction 1502. The log write instruction 1502 includes arguments identified with “$” that are filled at the time the log message is created. For example, the log write instruction 1502 includes a time-stamp argument 1504, a thread number argument 1506, and an internet protocol (“IP”) address argument 1508. The example log write instruction 1502 also includes text strings and natural-language words and phrases that identify the level of importance of the log message and type of event that triggered the log write instruction, such as “Repair session” 1508. The text strings between brackets “[ ]” represent file-system paths, such as path 1510. When the log write instruction 1502 is executed, parameters are assigned to the arguments and the text strings and natural-language words and phrases are stored as a log message of a log file.

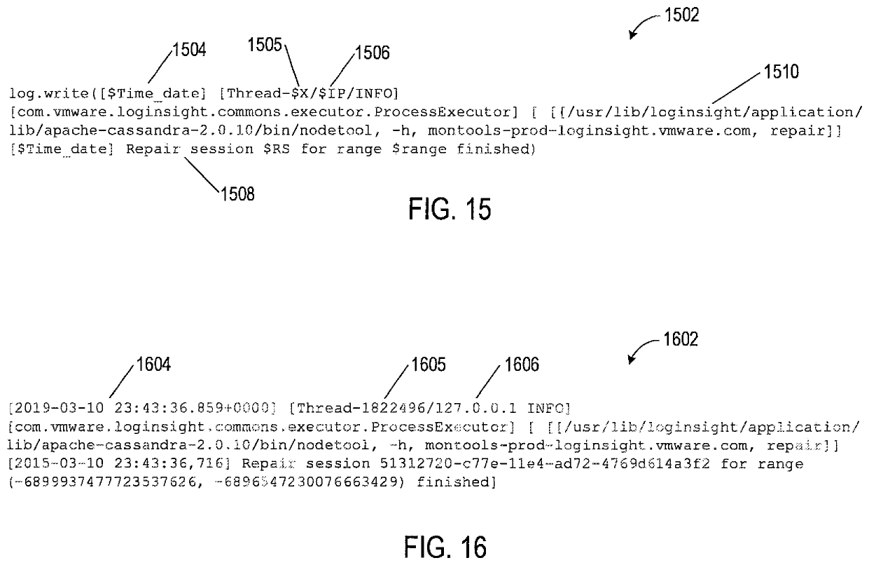

FIG. 16 shows an example of a log message 1602 generated by the log write instruction 1502. The arguments of the log write instruction 1502 are assigned numerical parameters that are recorded in the log message 1602 at the time the write instruction is executed. For example, the time stamp 1504, thread 1506. and IP address 1508 arguments of the log write instruction 1502 are assigned corresponding numerical parameters 1604, 1606, and 1608 in the log message 1602. The time stamp 1604 represents the date and time the log message is generated. The text strings and natural-language words and phrases of the log write instruction 1502 also appear unchanged in the log message 1602 and may be used to identify the type of event (e.g., informative, warning, error, or fatal) that occurred during execution of the event source.

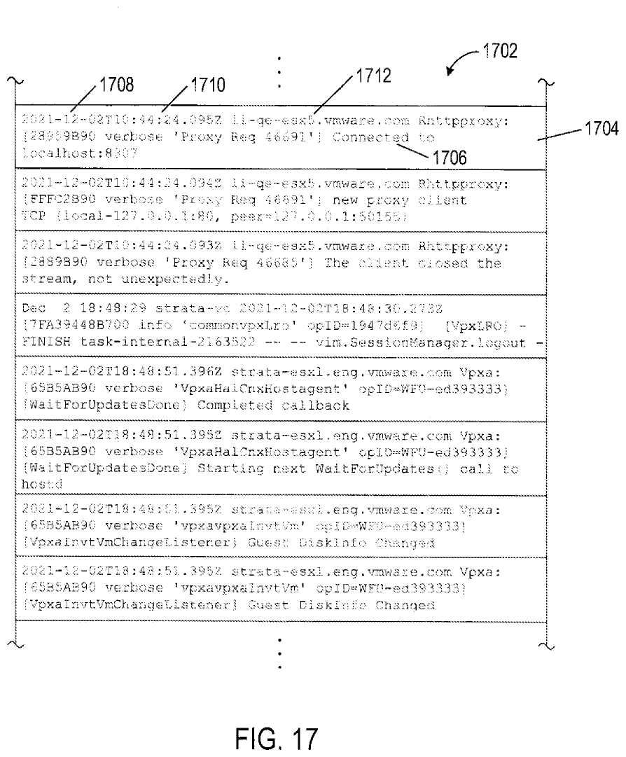

As log messages are received at the log management server from various event sources, the log messages are stored in corresponding log files in the order in which the log messages are received. FIG. 17 shows a small, eight-entry portion of a log file 1702. In FIG. 17, each rectangular cell, such as rectangular cell 1704, of the log file 1702 represents a single stored log message. For example, log message 1704 includes a short natural-language phrase 1706, date 1708 and time 1710 numerical parameters, and an alphanumeric parameter 1712 that identify a particular host computer.

### Computer-implemented Methods and Systems for Building an Ontology

In recent years, an increasing number of businesses, governments, and other organizations rent data processing services and data storage space as data center tenants. Data center tenants conduct business and provide cloud services over the internet on software platforms, such as SDDCs, that are maintained and run entirely in data centers, which reduces the cost of maintaining their own centralized computing networks and hosts. Other organizations have selected a hybrid cloud model in which certain applications and services are run on the computer systems that are owned and maintained by the organizations while other applications and services are executed in data centers. As a result of the increasing demand to execute applications, store data, and provide services over the internet using data center resources, data centers have grown exponentially with enormous numbers of computational resources used for executing tens of thousands of applications.

To aid systems administrators and data center tenants with detection of hardware and software performance problems, various management systems have been developed to collect performance information. As described above, a typical log management tool records log messages generated by various operating systems and applications running in a data center in log files. However, vast numbers of log files are generated each day with most log files exceeding a tera byte of data. These large volume log files are expensive for data center tenants to maintain in storage. Large volume log files also slow the process of detecting performance issues recorded in log messages. The search for log messages that reveal the root cause of a performance issue, for example, is exacerbated by inconsistent logging practices and lack of procedures for handling log messages. As a result, a search for log messages that indicate a problem with a tenant's application is typically performed by sophisticated teams of engineers, such as a field engineering team, an escalation engineering team, and a research and development engineering team. However, because of the enormously large size of most log files, the troubleshooting process can take days and weeks, and in some cases even longer. To complicate matters further, the types of individuals who analyze log messages has expanded from specialized teams of engineers to include users with varying levels of expertise in interpreting log messages. Data center tenants cannot afford long periods of time spent searching log files for log messages that reveal a root cause of a performance problem that causes downtime or slows performance of their applications. Such problems frustrate users. damage a brand name, cause lost revenue, and deny people access to vital services. Systems administrators and data center tenants seek automated methods and systems that reduce the complexity and shorten the time to detection of root causes of performance issues.

Typical log management tools allow a user to search through log messages across a myriad of products and applications running in a data center. The products are platforms that execute operations and provide services that enable data center tenants to manage execution of their applications in the data center.

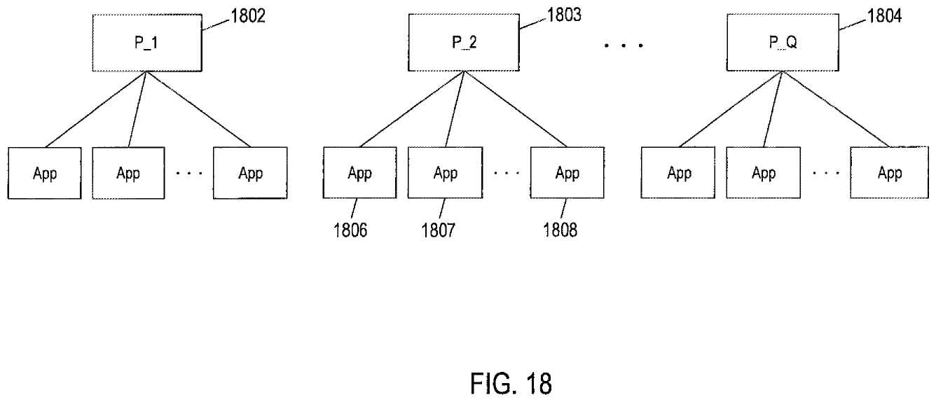

FIG. 18 shows an example graph of hierarchy of products and applications of a system executing in a data center. The system can be, for example, a server computer, a VM, a container, a distributed application, or an SDDC of a data center tenant. Lines connecting blocks represent mappings between products to applications that run on platforms of the products. Blocks 1802-1804 represent three of Q products identified as P_1, P_2, . . . , P_Q that serve as platforms for executing applications in the computing system. Blocks identified as “App” and connected to the products P_1, P_2, . . . , P_Q represent applications that execute on the platforms provided by the corresponding products. For example, product P_2 is a platform for executing the applications represented by blocks 1806-1808.

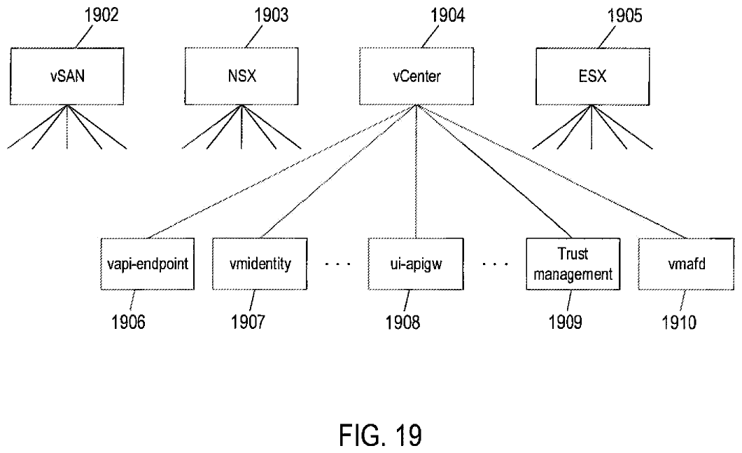

FIG. 19 shows a graph of actual products that serve as platforms for running applications in a data center. In this example, blocks 1902-1905 represent products provide by VMware, Inc. for running applications in a data center. Block 1902 represents the product vSAN, which aggregates local and direct-attached data storage devices across a cluster to create a single data store that all hosts in the cluster can share. Block 1903 represents the product NSX, which is a network virtualization and security platform that enables a virtual cloud networks and is a software-defined tool for networking containers and VMs across a data center. Block 1904 represents the product vCenter, which is a tool that enables management of SDDCs, VMs, and containers from a centralized location. Block 1905 represents the product ESX, which is a hypervisor, such as the virtualization layer 504 in FIG. 5, that abstracts processor, memory, storage, and networking resources into multiple VMs. In this example, lines extending between the applications represented by blocks 1906-1910 represent mappings between the applications and the product vCenter 1904. In other words, the applications represented by blocks 1906-1910 execute on the platform provided by vCenter 1904. Lines extending from blocks 1902, 1903, and 1905 represent mappings of other applications (not shown) to the platforms vSAN, NSX, and ESX.

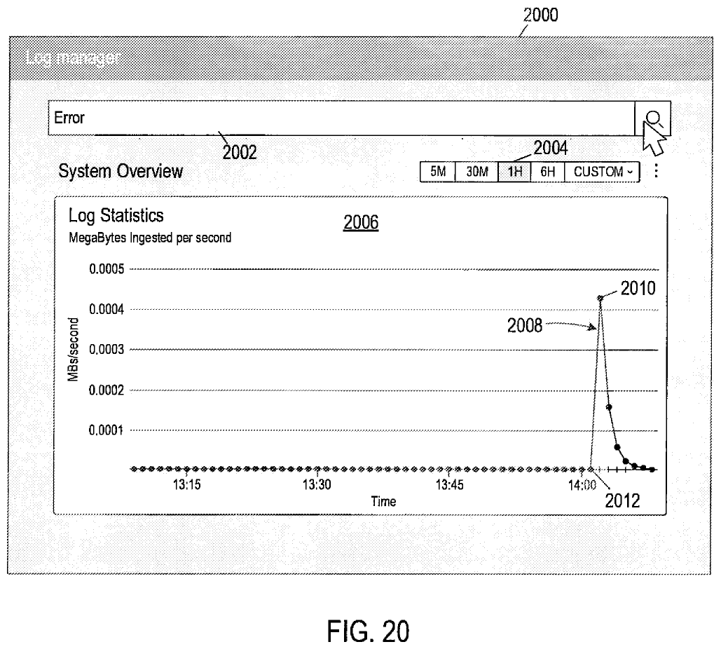

Typical log management tools provide a user interface that includes a search box as a means of exploring log files produced by the applications and the products. FIG. 20 shows an example of a typical user interface 2000 of a log management tool. The user interface 2000 includes a search box 2002. A users inputs a search term in the search box 2002. In this example, a user has input a search term “error” in the search box 2002 for a one-hour time interval 2004. The typical log management tool searches for log messages in log files of a system with the term “error” in the one-hour time interval. Window 1806 displays an example plot of search results. Fach solid point represents the number of log messages with the search term “error” that occurred in a subinterval of the one-hour time interval. In this example, the plot reveals a spike 2008 in log messages with the term “error.” Point 2010 is the number of log messages with the term “error” in the subinterval 2012. The plot displayed in window 2006 reveals a sharp increase in log messages with the term “error.” However, the search does not reveal which applications and products are associated with the increase in error log messages.

As workloads move toward public and hybrid cloud infrastructures and the number of users of these technologies grows, simple searches, such as the search described above with reference to FIG. 20, are not helpful in identifying log messages that can be used to identify the root cause of a performance issue. Existing performance issues stemming from inconsistent logging practices and a lack of best practices guidance are deeply exacerbated as the number of applications and users of public and hybrid cloud infrastructures continues to grow. In addition, the types of users who use log messages to analyze performance issues has grown from sophisticated teams of engineers to users with varying levels of expertise in systems administration and knowledge of the complex domains used to run their applications. As a result, the user experience of log analysis to detect performance issues must evolve to meet these varying skill levels of the users seeking to detect and resolve performance issues in their applications.

This disclosure presents an automated method that is executed in a log management system to intelligently construct a navigable tiered ontology. The navigable ontology is constructed from log messages associated with applications executed on products of the distributed computing system. The log messages are queried for a user selected time frame and represents an explicit structure of log messages, which is an alternative to traditional approaches to analysis of log messages. The ontology is displayed in a user interface as flow map that enable users at various levels of expertise to see how the log messages are distributed across products, applications, and event types and identify the log messages and event types for resolving performance problems with applications.

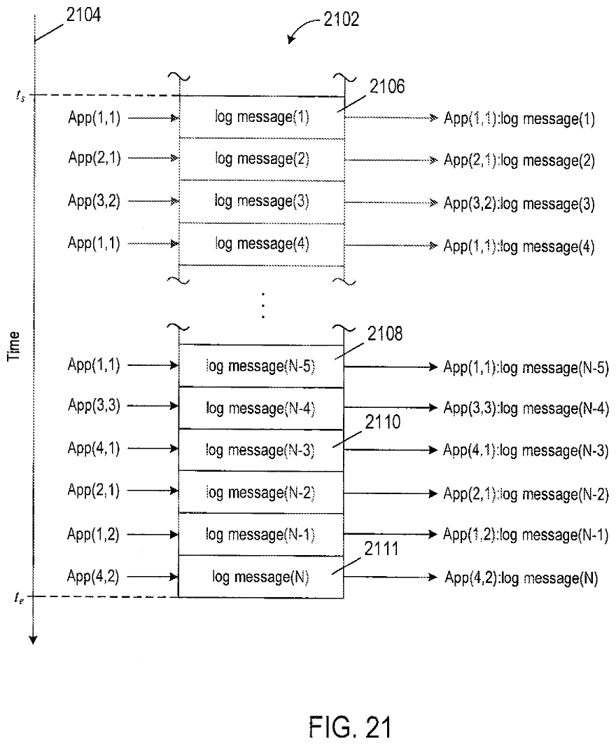

FIG. 21 shows an example set of log messages with time stamps in a user selected time frame [tₛ, tₑ], where tₛ denotes the start time of the time frame and tₑ denotes the end time of the time frame. The set of log messages are represented by a column of rectangles 2102. Directional arrow 2104 represents increasing time. Each log message is associated with an application of a system executing in a data center. The system may be a VM, a container, a distributed application, or an SDDC running in the data center. In FIG. 21, log messages are denoted by “log message(n).” where n is a positive integer index used to distinguish the log messages. Applications are denoted by “App(q,r),” where q and r are positive integer indices that distinguish the products and the applications from one another, respectively. For example, log messages 2106 and 2108 correspond to the same application App(1,1). Log messages 2110 and 2112 are associated with different applications that are executed on the same product platform. The products, applications, and log messages generated in the time frame form the input for constructing a navigable ontology of the system.

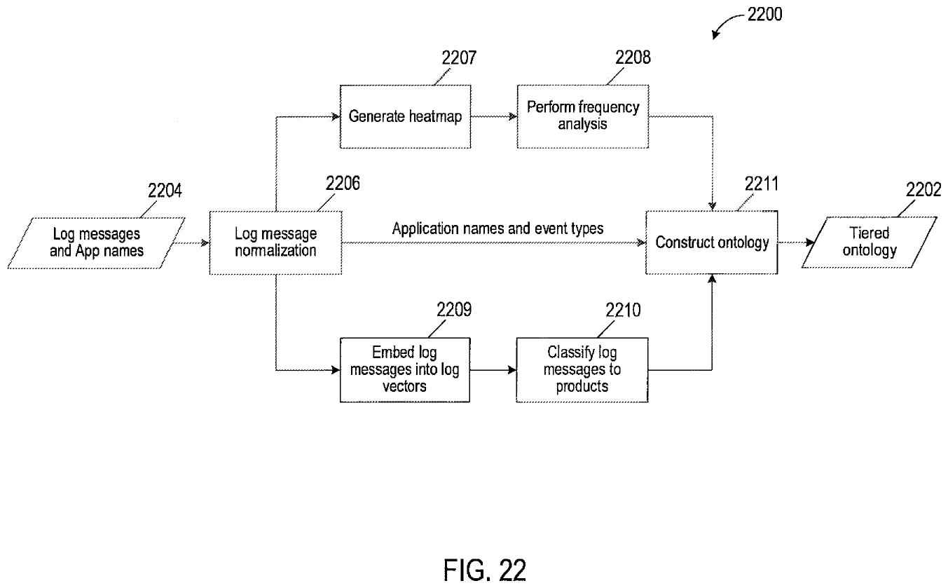

FIG. 22 shows a data pipeline 2200 for constructing a navigable tiered ontology 2202 from a set of log messages, products, applications 2204 queried in a user selected time frame [tₛ, tₑ]. The pipeline 2200 comprises a series of processing elements represented by blocks 2206-2211 where the output of one processing element is input to a next processing element. As shown in FIG. 22, the processes represented by blocks 2207 and 2208 can be performed in parallel with the processes represented by blocks 2209 and 2210 on the output from the processing element 2206. In block 2211, the tiered ontology 2202 is constructed from products, applications, and event types output from block 2206, the frequency analysis output from block 2208. and the log messages classes output from block 2210. The operations performed at each of the processing elements 2206-2211 are discussed separately below.

### Normalization

In block 2206 of FIG. 22, the log management system normalizes the log messages 2204 with time stamps in the user selected time frame [tₛ, tₑ], where tₛ denotes the start time of the time frame and te denotes the end time of the time frame. As explained above, log messages often contain various parametric information, such as timestamps, field values, and IP addresses and include stop words that not helpful for revealing the type of events that triggered creation of the log messages. Log messages also contain non-parametric tokens that describe the type of events (i.e., event types) that triggered creation of the log message. Many log messages record benign events while other log messages record events, such as warnings or critical problems. Normalization extracts parametric and non-parametric strings of characters called tokens from preprocessed log messages. Log messages that belong to the same event types have different parametric tokens but the same set of non-parametric tokens. The tokens that correspond to parametric information are discarded, leaving non-parametric tokens that identify the event type that triggered creation of the log messages. Normalization prepares the text of the log messages for input to the processing elements 2207, 2209, and 2211. In block 2206, normalization includes using natural language processing (“NLP”) that corrects for errors, removes redundancies, and removes stop words from the log messages. NLP also identifies important words and convert words to fit a vocabulary of words.

Preprocessing of log messages is executed as a data processing pipeline arranged so that the output of each processing element is the input of the next processing element. A first processing element converts capital letters into lower case letters. For example, the token “CPU” is converted into “cpu.” A second processing element corrects encoding issues in a log messages, such as correcting garbled text. For example, the term [symbol] \9e contains garbled text associated with quotations that is translated into “quote”. A third processing element decodes HTML character codes. For example, the HTML character code. &amp, is decoded into just &. A fourth processing element decodes Unicode characters into the nearest ASCII equivalent. For example, the word “resume” is decoded into the word “resume”. A fifth processing element reduces long strings of repeated characters that are semantically meaningless to single characters. For example, repeated characters “ [symbol] ” and “ [symbol] ” are reduced to “ [symbol] ” and “ [symbol] ”. respectively. A sixth processing element removes brackets, curly braces, parenthesis, quotations, and pipes. For example, brackets, curly braces, parenthesis, and pipes of the term “[statement] clear( ) {return output|stable}” are removed to give the term “statement clear return output stable”.

In one implementation, normalization is executed using regular expressions that are constructed to extract parametric and non-parametric tokens from preprocessed log messages. A regular expression, also called “regex,” is a sequence of symbols that defines a search pattern in text data. Many regex symbols match letters and numbers. For example, the regex symbol “a” matches the letter “a,” but not the letter “b,” and the regex symbol “100” matches the number “100.” but not the number 101. The regex symbol “.” matches any character. For example, the regex symbol “.art” matches the words “dart,” “cart,” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a+b” matches ab and aaab but does not match b or baa. Other regex symbols include a “\d” that matches a digit in 0123456789, a “\s ” matches a white space, and a “\b” matches a word boundary. A string of characters enclosed by square brackets. [ ], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [ [symbol] %+−] matches any one of the characters [symbol] %+−. The regex [0-9a-f] matches a number in 0123456789 and a single letter in abcdef. For example, [0-9a-f] matches a6, i5, and u2 but does not match ex, 9v, or %6. Regular expressions separated a vertical bar “ [symbol] ” represent an alternative to match the regex on either side of the bar. For example, the regular expression Get|Get Value|Set Set Value matches any one of the words: Get, GetValue. Set. or Set Value. The braces “{ }” following square brackets may be used to match more than one character enclosed by the square brackets. For example. the regex [0-9] {2} matches two-digit numbers, such as 14 and 73 but not 043 and 4, and the regex [0-9]{1-2} matches any number between 0 and 99, such as 3 and 58 but not 349.

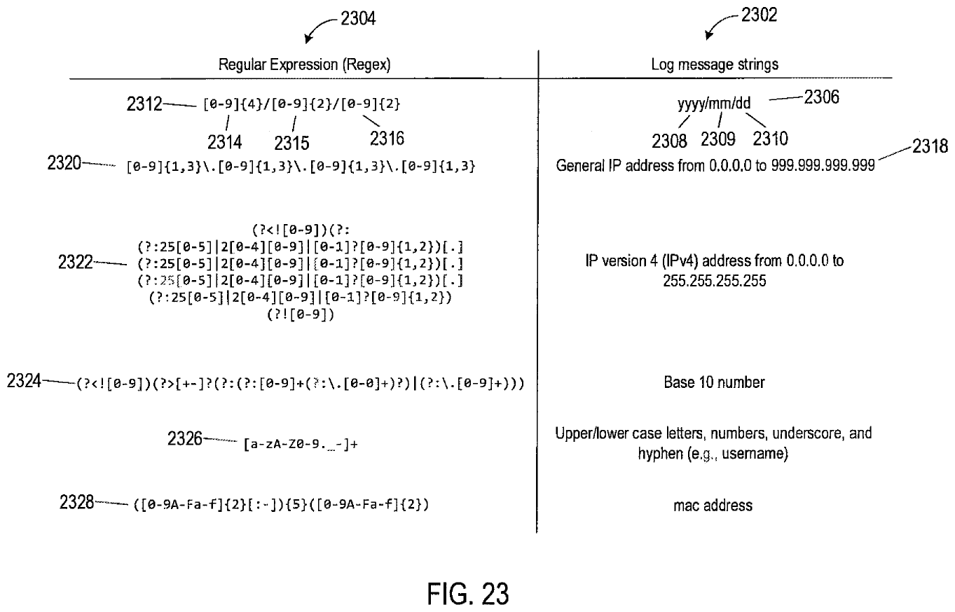

Simple regular expressions are combined to form larger regular expressions that match character strings of log messages and can be used to extract the character strings from the preprocessed log messages. FIG. 23 shows a table of examples of regular expressions designed to match particular character strings of log messages. Column 2302 list six different types of strings that may be found in log messages. Column 2304 list six regular expressions that match the character strings listed in column 2302. For example, an entry 2306 of column 2302 represents a format for a date used in the time stamp of many types of log messages. The date is represented with a four-digit year 2308, a two-digit month 2309, and a two-digit day 2310 separated by slashes. The regex 2312 includes regular expressions 2314-2316 separated by slashes. The regular expressions 2314-2316 match the characters used to represent the year 2308, month 2309, and day 2310. Entry 2318 of column 2302 represents a general format for internet protocol (“IP”) addresses. A typical general IP address comprises four numbers. Each number ranges from 0 to 999 and each pair of numbers is separated by a period, such as 27.0.15.123. Regex 2320 in column 2304 matches a general IP address. The regex [0-9]{1-3} matches a number between 0 and 999. The backslash “1” before each period indicates the period is part of the IP address and is different from the regex symbol “.” used to represent any character. Regex 2322 matches any IPv4 address. Regex 2324 matches any base-10 number. Regex 2326 matches one or more occurrences of a lower-case letter, an upper-case letter, a number between 0 and 9, a period, an underscore, and a hyphen in a character string. Regex 2328 matches mac addresses. The complex patterns regexes that match time stamps, IP addresses and mac addresses, volume IDs, version numbers and other hexadecimal IDs are mapped to simple words that represent the complex patterns. The following are examples of complex patterns and corresponding simple words:

TABLE

| Complex patterns | Simple words |
|---|---|
| 2022-05-03T01:59:50.817Z +0000 | Timestamp |
| 2620:124:6020:c002 | IP address |
| 127.0.0.1:8000 | MAC address |
| 7.0.0-0.0.32156387 | Version number |
| 5accf9a3-226ee135-7ca6-0025b521a1b4 | Volume ID |
| 0xFFC67FF0 | Hex ID |

The parameter tokens and simple words are discarded from preprocessed log messages, leaving non-parametric tokens that identify the type of event (i.e., event type) that triggered generation of the log message.

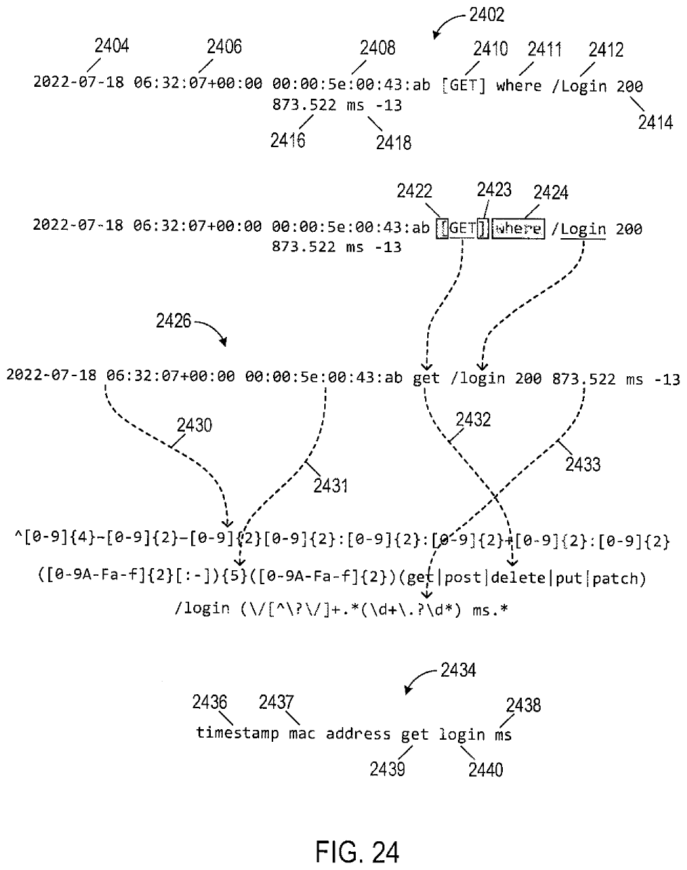

FIG. 24 show an example of NLP preprocessing and normalizing an example log message 2402. The log message 2402 includes a date 2404, time 2406, MAC address 2408, word tokens 2410-2412, an HTTP response code 2414, and a response time 2416 in units of milliseconds 2418. In this example, preprocessing detects brackets 2420, the stop word “where” as indicated by shaded rectangles 2422-2424, and words with capital letters. The preprocessing pipeline removes the backets and the stop word and converts capital letters into lower case letters to obtain preprocessed log message 2426. A regex 2428 is constructed to extract tokens from the preprocessed log message 2426 is used to extract tokens from preprocessed log message 2426. For example, dashed directional arrows 2430-2433 connect capture groups of the regex 2428 that extract the date 2404 and time 2406 of the time stamp. extract the token “get” 2410, and extract the response time 2416. The parametric tokens, such as the HTTP response code and the response time 2416. are discarded and simple words are substituted for the complex patterns to obtain a reduce log messages 2434. The simple words 2436 and 2437 and the abbreviation 2438 are discarded leaving non-parametric tokens 2439 and 2440, which form the normalized log message 2442.

In another implementation, non-parametric tokens are extracted from preprocessed log messages using Grok expressions. Grok patterns are predefined symbolic representations of regular expressions that reduce the complexity of constructing regular expressions. Grok patterns are categorized as either primary Grok patterns or composite Grok patterns that are formed from primary Grok patterns. A Grok pattern is called and executed using the notation Grok syntax % {Grok pattern}.

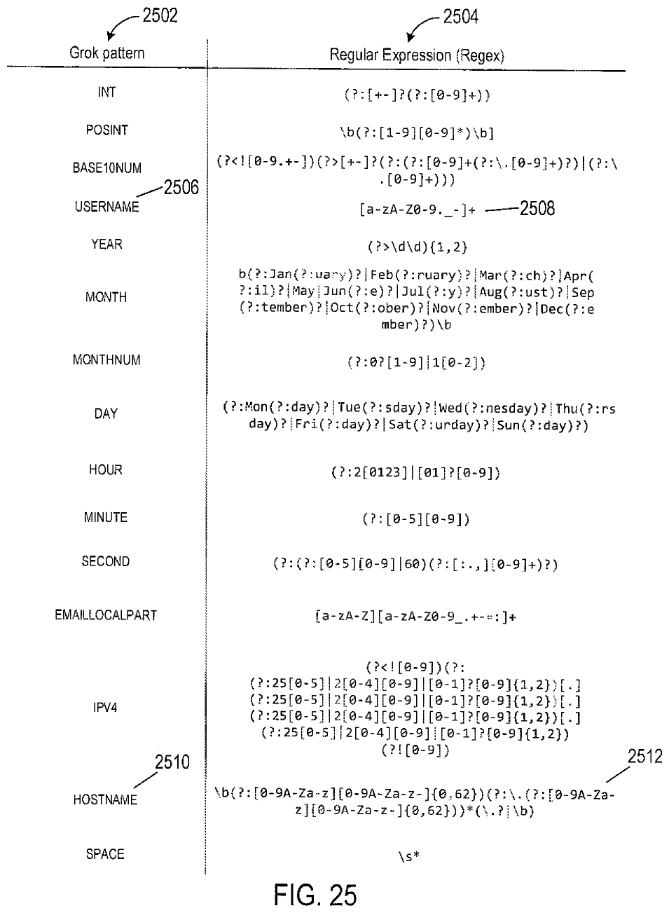

FIG. 25 shows a table of examples of primary Grok patterns and corresponding regular expressions. Column 2502 contains a list of primary Grok patterns. Column 2504 contains a list of regular expressions represented by the Grok patterns in column 2502. For example, the Grok pattern “USERNAME” 2506 represents the regex 2508 that matches one or more occurrences of a lower-case letter, an upper-case letter, a number between 0 and 9, a period, an underscore, and a hyphen in a character string. Grok pattern “HOSTNAME” 2510 represents the regex 2512 that matches a hostname. A hostname comprises a sequence of labels that are concatenated with periods. Note that the list of primary Grok patterns shown in FIG. 25 is not an exhaustive list of primary Grok patterns.

Grok patterns may be used to map specific character strings into dedicated variable identifiers. Grok syntax for using a Grok pattern to map a character string to a variable identifier is given by:

%{GROK_PATTERN:variable_name}

where
GROK_PATTERN represents a primary or a composite Grok pattern; and
variable_name is a variable identifier assigned to a character string in text data that matches the GROK_PATTERN.
   A Grok expression is a parsing expression that is constructed from Grok patterns that match characters strings in text data and may be used to parse character strings of a log message. Consider, for example, the following simple example segment of a log message:

34.5.243.1 GET index.html 14763 0.064

A Grok expression that may be used to parse the example segment is given by:

\hat{ }%{IP:ip_address}\s%{WORD:word}{URIPATHPARAM:request}is %{INT:bytes}\s%{NUMBER:duration}$

The hat symbol “\hat{ }” identifies the beginning of a Grok expression. The dollar sign symbol “$” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064
   Grok expressions are constructed to match token patterns of preprocessed log messages and extract the tokens. The parametric tokens are discarded, leaving the non-parametric tokens that describe the event types of the log messages.

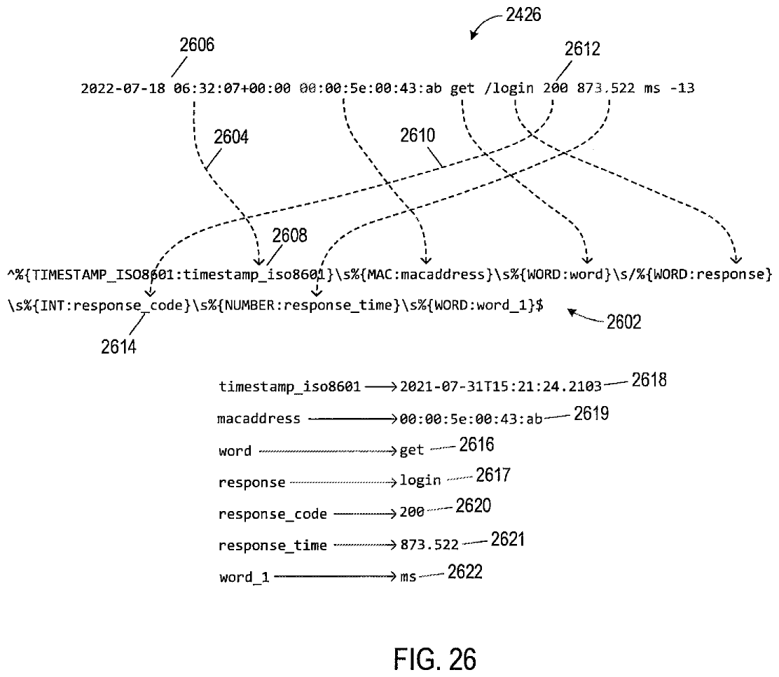

FIG. 26 shows an example of a Grok expression 2602 constructed to extract tokens from the preprocessed log message 2426. Dashed directional arrows represent parsing the log message 2426 such that tokens that correspond to Grok patterns of the Grok expression 2602 are assigned to corresponding variable identifiers. Dashed directional arrows represent assigning tokens of the log message 2426 to variable identifiers of the Grok expression 2602. For example, dashed directional arrow 2604 represents assigning the time stamp 2021-07-18T06:32:07+00:00 2606 to the variable identifier timestamp_iso8601 2608 and dashed directional arrow 2610 represents assigning HTTP response code 200 2612 to the variable identifier response code 2614. FIG. 26 also shows assignments of tokens of the log message 2426 to the variable identifiers of the Grok expression 2602. The non-parametric tokens 2616 and 2617 remain to give the normalized log message 2618.

Log messages may contain stop words. Stop words are common words that are of little value in identifying the event types recorded in log messages. Stops words include, but are not limited to, “a,” “an,” “and,” “are,” “as,” “at,” “be,” “by,” “for,” “from,” “has,” “in,” “is,” “it,” “its,” “of,” “on,” “that,” “the,” “to,” “was,” “were, ” “will” and “with,” Stop words can include units, such as time units, that are of no value. After parametric tokens have been removed from the log messages, normalization removes stop words from the normalized log messages.

Normalization replaces tokens that represent abbreviations of words with words that fit an embedding vocabulary described below with reference to block 2209. For example, the tokens “cfg,” “conf,” and “config” are abbrviations of the word “configuration.” Normalization replaces the tokens “cfg, ” “conf,” and “config” with the token “configuration.” Normalization also replaces the token “cmd” with the token “command” and replaces the token “param” with the token “parameter.” Consider, for example, a normalized log message composed of the non-parametric tokens “received cmd for login” that has been extracted using a regex or a Grok expression as described above. Normalization replaces abbreviated token “cmd” to obtain the normalized log message “received command for login.”

### Generate Heatmap

Returning to FIG. 22, in block 2207, the log management system generates a heatmap of the types of events, or event types, output from normalization processing element 2206. For example, normalization of log messages of the form of the log message 2406 will have the same normalized vocabulary “get login” but have different parametric tokens, such as different time stamps. These log messages belong to the same event type. In the following discussion event types are denoted by ett, where the index i distinguishes different event types.

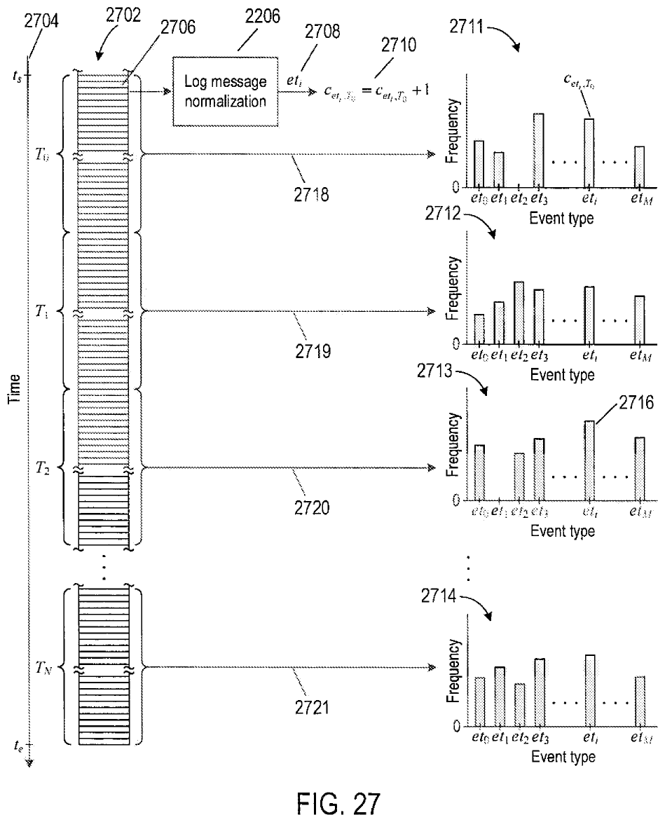

FIGS. 27-29 show generating a heatmap of event types of the log messages in time windows of the user-selected time frame. FIG. 27 shows an example of determining event-type distributions of event types generated in adjacent time windows. A column of rectangles 2702 represents the log messages in the time frame [tₛ, tₑ]. Directional arrow 2704 represents increasing time. Each rectangle, such as rectangle 2706, represents a log message. Adjacent time windows denoted by T₀, T₁, T₂ . . . , T_{N} are represented by brackets.

Each time window is a duration of time with a beginning time and an ending time that encompasses time stamps of log messages that lie within the time window. At the beginning of each time window, counters associated with each event type are reset to zero. Let Cₑₜ_{₁}_{, T}_{ₙ} denote a count of the number of times log messages with the same event type etᵢ occurred in the time window Tₙ. The event-type counter is set equal to zero for each event type at the beginning of each time window. The preprocessing normalization processing element 2206 generates the event type of each log message in the log messages 2702 as described above with reference to FIG. 23-26. The event-type counter of the event type generated by the processing element 2206 is incremented. At the end of each time window, an event-type distribution is calculated for the event types generated in each time window. The event-type distribution is a count of the number of times an event type is generated in a time window. Example event-type distributions 2711-2714 represent the frequencies (i.e., counts) of the event types generated in the corresponding time windows T₀, T₁, T₂, and T_{N}. For example. bar 2716 in distribution 2713 represents the event-type count Cₑ_{₁}_{,T}_{₂} of the number of log messages with the event type etᵢ generated in the time window T₂. Directional arrows 2718-2721 represent computing the event-type distributions 2711-2714 for the event types generated in the time windows T₀, T₁, T₂ . . . , T_{N}.

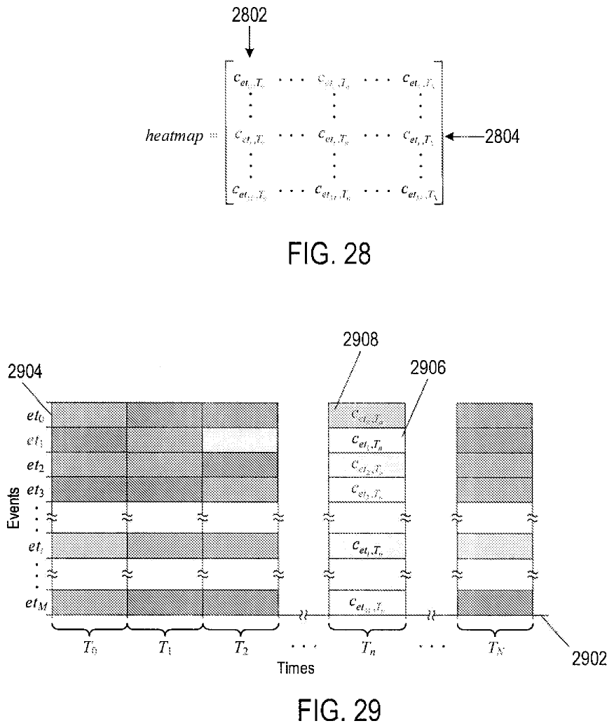

FIG. 28 shows a heatmap matrix of the event-type counts of the event types generated in the time windows T₀, T₁, T₂ . . . , T_{N}. Each column, such as column 2802, represent the event-type counts of the event types generated in a time window. Each row, such as row 2804, represents the event-type counts of the event types generated in the adjacent time windows.

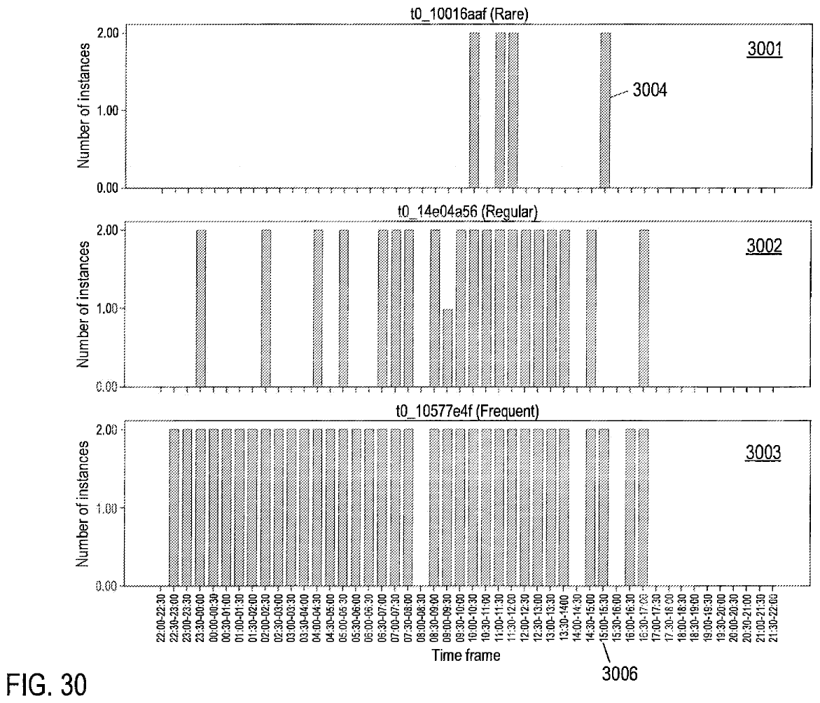

FIG. 29 shows a portion of an example event-type frequency heatmap. Horizontal axis 2902 represents time. Vertical axis 2904 represents the event types in the log messages. Shaded cells represent the count of an event type in a time window. The shading of each cell corresponds to an event-type count or frequencies. In this example, a lighter shaded cell represents a relatively lower range of event-type counts than a darker shaded cell. For example, the light shade cell 2906 represents an event-type count Cₑₜ_{₁}_{, T}_{ₙ} that is less than event-type count Cₑₜ_{₀}_{, T}_{ₙ} represented by darker shaded cell 2908.

### Frequency Analysis

Returning to FIG. 22. in block 2208 the event types are assigned a frequency classification based on the frequency of occurrence of each event type. The frequency of occurrence of each event type is computed over the time frame [tₛ, tₑ] as follows:

$$F ( e {t}_{i} ) = \frac{1}{{N}_{events}} {\sum }_{n = 1}^{N} {c}_{{et}_{i} , {T}_{n}} \qquad ( 1 )$$

$$where$$

$${N}_{events} = {{\sum }_{i = 1}}^{{N}_{ET}} {{\sum }_{n = 1}}^{N} {c}_{{et}_{i} , {T}_{n}}$$

and N_{ET} is the total number of event types generated in the time frame [tₛ, tₑ]. Thresholds are used to classify event types as rare, regular, and frequent. When the following condition is satisfied

F(etᵢ)<Thrₐᵣₑ (2a)

the event type etᵢ is classified as rare, where Thrₐᵣₑ is a rare occurrence threshold. When the following condition is satisfied

F(etᵢ)≥Thr_{freq} (2b)

the event type etᵢ is classified as frequent, where Th_{freq} is a frequent occurrence threshold. When the following condition is satisfied

Thᵣₐᵣₑ≤F(etᵢ)<Th_{freq} (2c)

the event type ett is classified as regular. In one implementation, the rare occurrence threshold is 0.333 and the frequent occurrence threshold is 0.666. In another implementation, the rare occurrence threshold is 0.25 and the frequent occurrence threshold is 0.50. Alternatively, the rare occurrence threshold is 0.50 and the frequent occurrence threshold is 0.75.

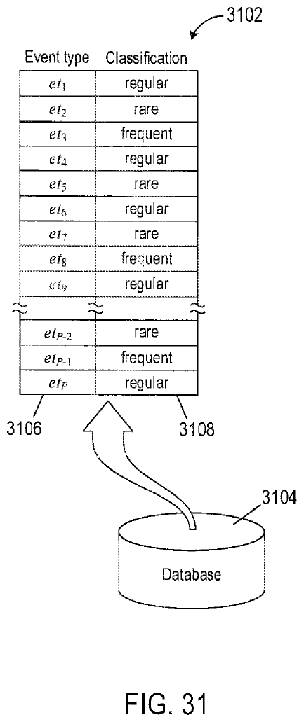

FIG. 30 shows example heatmap plots 3001-3003 for three different even types identified as “t0_10016aaf.” “10_14e04a56.” and “t0_10577e4f.” respectively. Horizontal axes represent a twenty-four-hour time frame. The time frame is partitioned into thirty-minute time windows. Vertical axes represent a count of instances of the event types. Each bar represents the number of instances of log messages with the event type occurring in a time window. For example, bar 3004 indicates two log messages with the event type t0_10016aaf occurred in the time window 3006. In this example, event type t0_10016aaf is classified as rare because the frequency of occurrence of the event type t0_10016aaf is less than the rare occurrence threshold. The event type t0_10577e4f is classified as frequency because the frequency of occurrence of the event type t0_10577e4f is greater than the frequent occurrence threshold. The event type t0_14e04a56 is classified as regular because the frequency of occurrence of the event type t0_14e04a56 lies between the rare and the frequent occurrence thresholds.

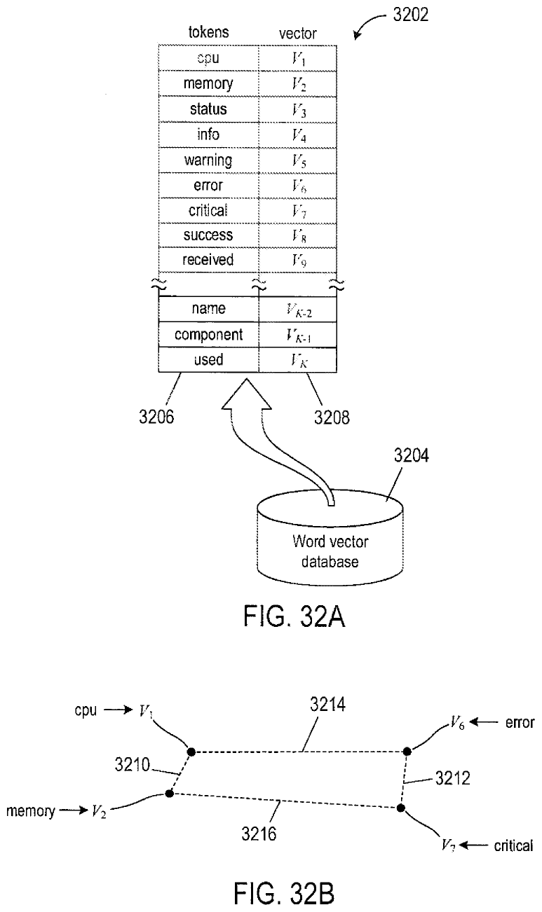

The event types and corresponding frequencies of occurrence of the time frame are stored in a database. FIG. 31 shows a table 3102 of example event types and corresponding frequency classification stored in an event type database 3104. Column 3106 list the event types. Column 3108 list the corresponding frequency classifications.

Embed Log Messages into Vectors

Returning to FIG. 22, in block 2209, the normalized log messages obtained in block 2206 are embedded into log vectors in an embedding space. Let Wg represent a word in a corpus C, where i=1, 2, . . . , N and N is the number of different words in the corpus. The corpus C is composed of words obtained from log messages generated over the time frame. Word vectors that correspond to the words in the corpus may be learned using an unsupervised machine learning algorithm. such as GloVe (“Glove: Global vectors for word representation”, J. Pennington et al., Proceedings of the 2014 conference on empirical methods in natural language processing, pp. 1532-1543 (2014)) and Word2vec (“Efficient estimation of word representations in vector space”. T. Mikolov et al., In proceedings of Workshop at ICLR (2013)). With GloVe, training is performed on aggregated global word-word co-occurrence statistics from the corpus, and the resulting vector representations of the words exhibit linear substructures of the embedding space. Word vectors may also be created as domain specific embedding of the NLP. The word vector for the word Wg is denoted by

$${V}_{q} = [ \begin{matrix}{v}_{q , 1} \\ ⋮ \\ {v}_{q , {N}_{e}}\end{matrix} ] \qquad ( 3 )$$

where
Nₑ is the number of elements (i.e., features) in each word vector (i.e., Nₑ-dimensional embedding space); and
v_{q,1}, . . . , v_{q, N}_{ₑ} are real numbers.

In practice, the word vectors can be in a high dimensional space. For example, the word vector may have 100 elements (e.g . . . Nₑ=100) and the embedding space may be a 100-dimensional space. The resulting word vectors lend themselves to relative techniques such as nearest neighbors and linear substructures. Nearest neighbor means that similar words have a similar word vector representation. Linear substructures enable quantifying the relationships between words.

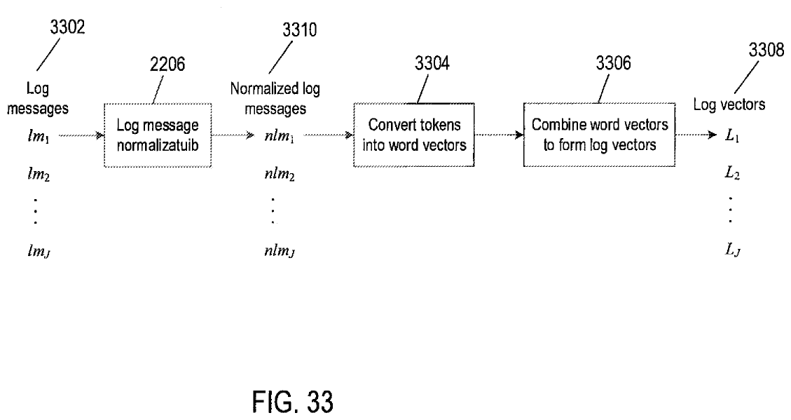

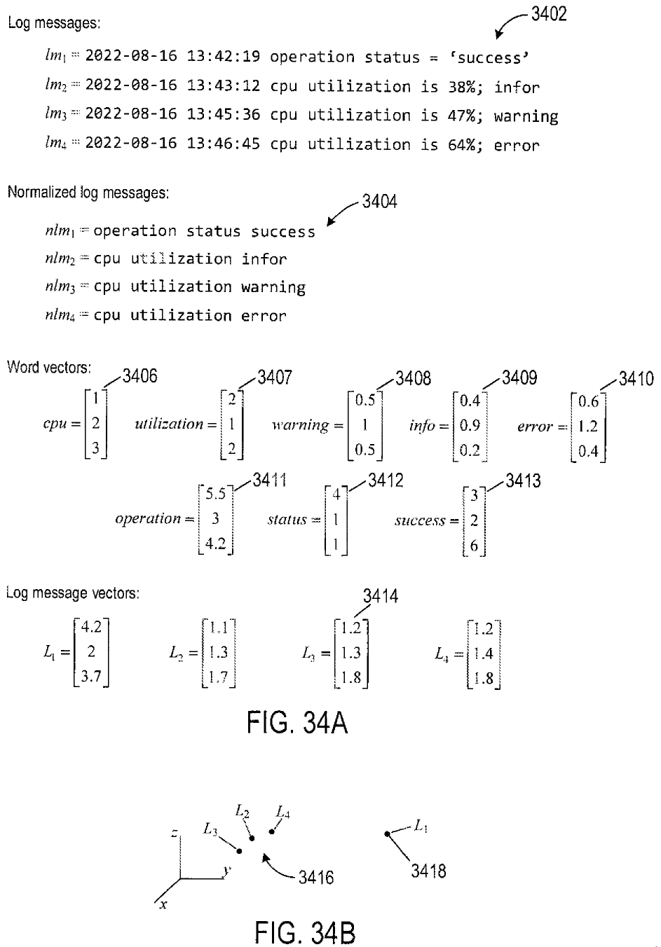

FIG. 32A shows a table 3202 of example tokens and corresponding word vectors stored in a word vector database 3204. Column 3206 contains a list of tokens that appear in log messages. Column 3208 contains a list of word vectors that correspond to the tokens. Each word vector represents a corresponding token as a point in an embedding space. FIG. 32B shows an example of word vectors and corresponding words in the embedding space. Note that for the sake of convenience, the word vectors are represented in a two-dimensional space. In practice, the embedding space can be a much higher dimensional space and cannot be visualized. In FIG. 32B, solid points represent word vectors V₁, V₂, V₆, and V₇, of corresponding words “cpu,” “memory,” “error,” and “critical.” Similarity metrics between two word vectors, such as Euclidean distance or cosine similarity, provide a measure of the linguistic or semantic similarity of the corresponding words. The similarity metrics used for nearest neighbor evaluations generate a scalar that quantifies the relatedness of two tokens. Dashed line 3210 represents the distance, or similarity, between the word vectors V₁ and V₂, Dashed line 3212 represents the distance, or similarity, between the word vectors V₆ and V₇. For example, the token “cpu” is similar to the token “memory” in the sense that both tokens describe hardware components of a computer system, but the tokens do not represent the same type of components. The token “error” is similar to the token “critical” in the sense that both tokens describe problems states of application processes, but the tokens do not represent problems requiring the same level attention. Dashed line 3214 represents the distance, or similarity, between the word vectors V₁ and V₆. Dashed line 3216 represents the distance, or similarity, between the word vectors V₂ and V₇. The distances 3214 and 3216 are an indication of how often the words cpu/error and memory/critical, respectively, appear together in the same log messages.

The word vectors of a normalized log messages are combined to obtain a log vector. Each log vector is an embedding of a log message in the embedding space. A log vector of a normalized log message with R word vectors denoted by Vᵣ, where r=1, . . . , R, is given by

$$L = [ \begin{matrix}{l}_{1} \\ ⋮ \\ {l}_{{N}_{e}}\end{matrix} ] \qquad ( 4 )$$

$$where$$

$${l}_{n} = \frac{1}{R} {\sum }_{r = 1}^{R} {v}_{r , n}$$

and V_{r,n} is the n-th element of the r-th word vector Vᵣ.

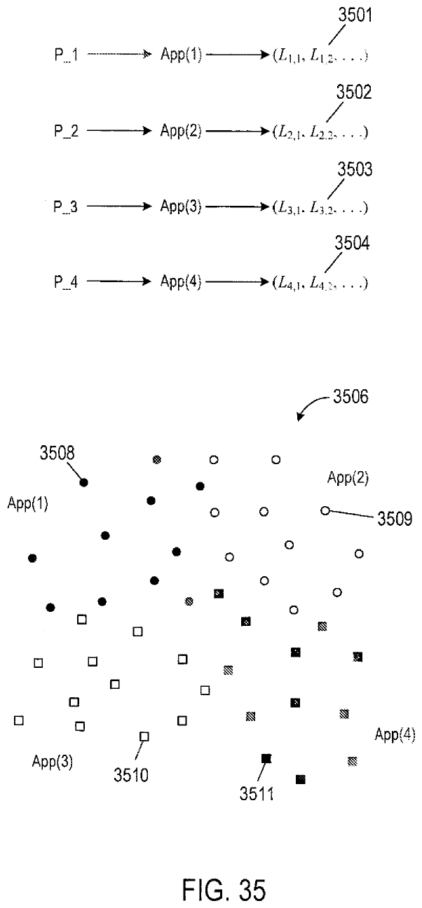

FIG. 33 shows a process of embedding log messages in log vectors. Column 3302 contains a list of J log messages generated in the time frame. The log messages are denoted by lₘ₁, lₘ₂, . . . , lₘⱼ. Blocks 2206, 3304, and 3306 represent operations of converting each log message in column 3302 into a correspond log vector listed in column 3308. In block 2206, each log message is normalized as described above to obtain corresponding normalized log messages, denoted nlₘ₁, nlₘ₂, . . . , nlₘⱼ, listed in column 3310. In block 3304, the non-parametric tokens in each of the normalized log messages are converted into corresponding word vectors in the word vector database 3204. In block 3306. the word vectors associated with each normalized log message are combined to give corresponding log vectors listed in column 3308.

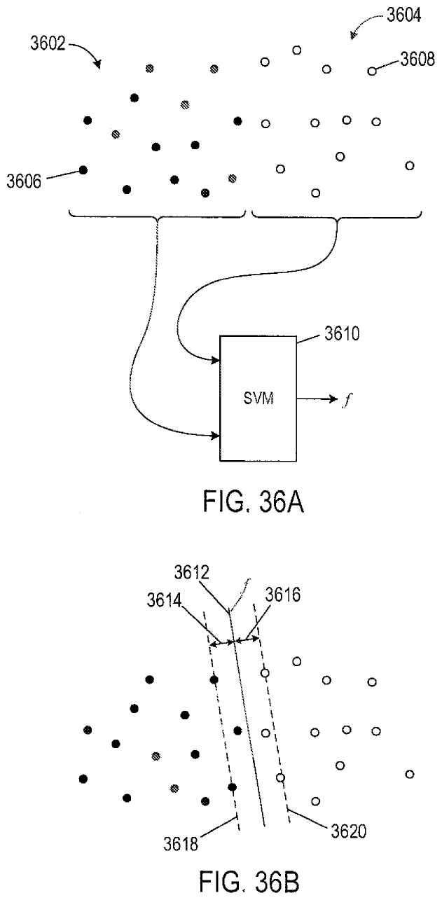

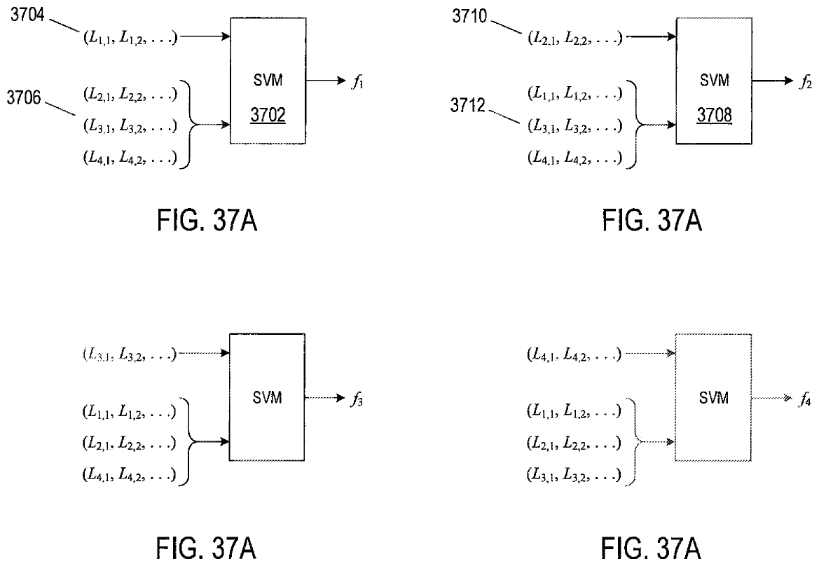

FIG. 34A shows an example of embedding four log messages into log vectors of a three-dimensional embedding space. The four log messages 3402 are denoted by lₘ₁, lₘ₂, lₘ₃, and lₘ₄. The log messages 3402 are normalized to remove parametric tokens, punctuation, and stop words and replace abbreviations with embedding vocabulary to obtain corresponding normalized log messages 3404 denoted by nlₘ₁, nlₘ₂, nlₘ₃, and nlₘ₄. In this example, the words in the normalized log messages correspond to word vectors 3406-3413 of the word vector database. Implementations are not limited to a three-dimensional space. In other implementations, higher dimensional spaces may be used to represent the words vectors. Log vectors denoted by L₁, L₂, L₃, and L₄ are computed by averaging word vectors that correspond to tokens in the normalized log messages according to Equation (4). For example, log vector L₃ 3414 corresponds to the normalized log message nlm₃ and is obtained by averaging corresponding components of the word vectors 3406-3408. The log vectors L₁, L₂, L₃, and L₄ are an embedding of the log messages lmₘ₁, lmₘ₂, lm₃, and lmₘ₄.

The log vectors that form a cluster of corresponding points in the embedding space belong to the same event type. A leader log message is determined for each cluster of log vectors. For each incoming log message, if the log vector of that log message shares more than a threshold of features in common with the log vector of the leader log message, then the incoming log message is tagged with the event type of the leader log message. Otherwise, the incoming log message is marked with a new event type and will be the leader log message for the new event type.

FIG. 34B shows an example plot of the log vectors by L₁, L₂, L₃, and L₄. The log vectors L₂, L₃, and L₄ correspond to log messages that report amount of CPU utilization events and are represented by a cluster of points 3416. Log vector L₁, on the other band. corresponds to a different event type and is represented by a point 3418 that is outside the cluster of points 3416. As a result, the log messages lₘ₂, lₘ₃, and lₘ₄ have the same even type and one of the log messages is selected as the leader log message. On the other hand, the log message lm₁ has a different event type and may be used as a leader log message for the event type.

### Classify Log Messages to Products

Returning to FIG. 22, in block 2210, support vector machines (“SVM”) are used to create classification models that are able to classify log messages to products. The model classifiers are obtained using supervised machine learning. The log vectors output from block 2209 are each associated with an application that, in turn, maps to a product as described above with reference to FIGS. 18 and 19. Each classification model is a non-probabilistic binary classifier. In other words, the classification models are intended for binary classification of two classes. In the following discussion, the products are the classes and the classification models are used to identify which class the log messages belong to.

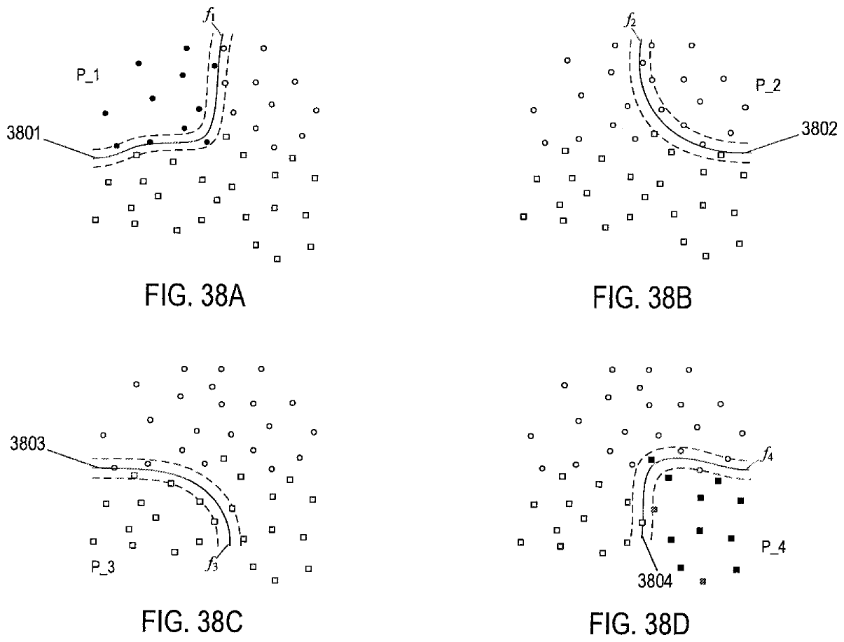

FIG. 35 shows an example of an embedding space for log vectors of four applications and products. The applications are denoted by App(1), App(2). App(3), and App(4). In this example, the applications App(1), App(2), App(3), and App(4) map to corresponding products P_1, P_2, P_3, and P_4. Each of the applications has a corresponding set of log vectors 3501-3504. The log vectors of the applications are denoted by L_{i,j}, where subscript i is a product index i=1,2, 3, 4 and subscript j is a log vector index with j=1, 2, . . . . FIG. 35 shows an example plot 3506 of the log vectors associated with each of the applications. For the sake of convenience, the log vectors are drawn in a two-dimensional space. In this example, closed points denote the log vectors associated with the application App(1). For example, closed point 3508 denotes log vector L_{1,1}. Open points denote the log vectors associated with the application App(2). For example, open point 3509 denotes log vector L_{2,1}. Open squares denote the log vectors associated with the application App(2). For example, closed point 3510 denotes log vector L_{3,1}. Closed squares denote the log vectors associated with the application App(4). For example, closed square 3511 denotes log vector L_{4,1}.

SVM technique is used to construct classification models that classify log messages with corresponding products. Each classification model characterizes a hypersurface that separates log vectors of log messages based on the corresponding product. A good separation is achieved by the hypersurface that has the largest distance to the nearest training log vectors of any class (so-called functional margin), since in general the larger the margin the lower the generalization error of the classifier. Consider a set of training log vectors Lⱼ∈ [symbol] ^{N}^{ₑ}, where j=1, . . . , n. Here the subscript associated with the product has been omitted. Each log vector Lⱼ is associated with an application that maps to a product. Let yⱼ be a class label for corresponding log vector Lⱼ with y₁, y₂, . . . , yₙ∈{−1,1}, where −1 denotes the first product and 1 denotes the second product. For example, if the log vector Lⱼ is associated with the first product, then the class identifier is yⱼ=−1. On the other hand, if the log vector Lⱼ is associated with a second product, then the class identifier is yⱼ=1.

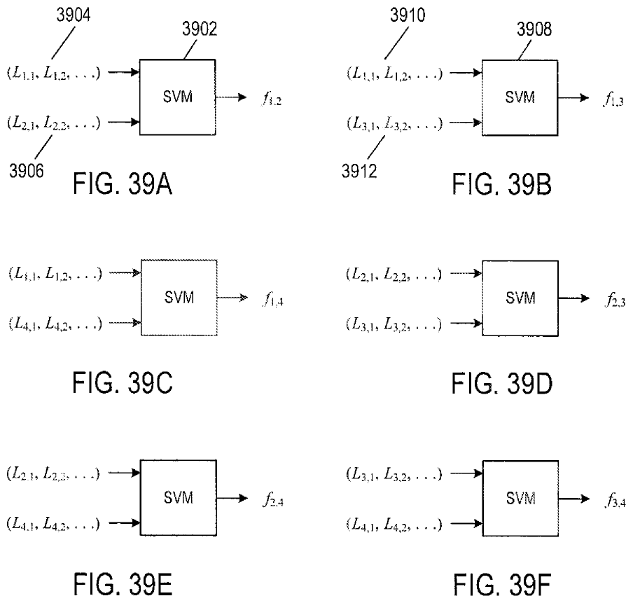

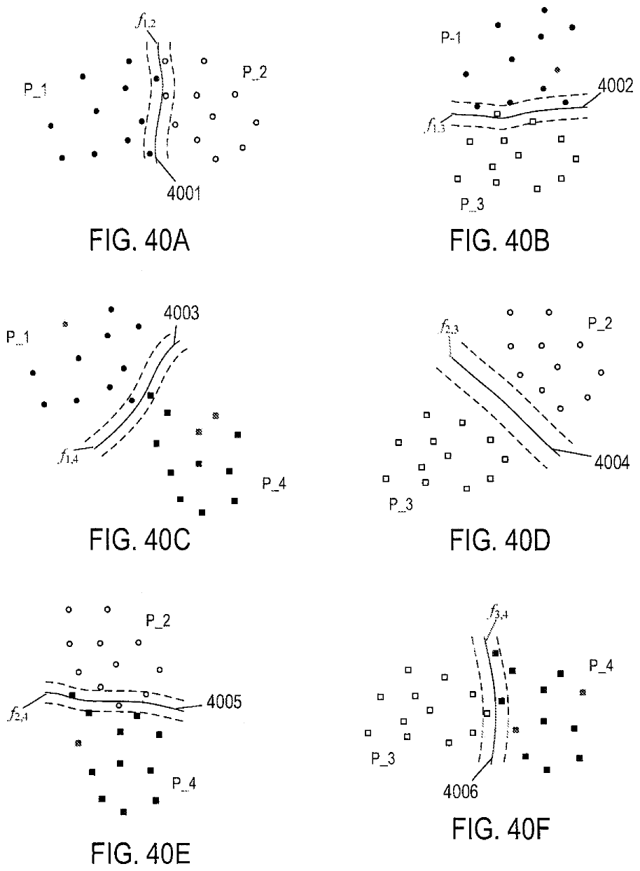

FIG. 36A shows an example of log vectors in an embedding space. Set of solid points 3602 represent log vectors associated with a first product. Set of open points 3604 represent log vectors associated with a second product. For example, solid point 3606 represents a log vector Lᵢ with class label yᵢ=1. Open point 3608 represents a log vector Lj with class label yⱼ=−1. The SVM technique represented by block 3610 uses the two sets of log vectors 3602 and 3604 as input to train a classification model denoted by f as described below. The classification model f characterizes a maximal margin hypersurface that separates the two set of log vectors and is used to classify log vectors of log messages. Support vectors are the log vectors located along the margins closest to the maximal margin hypersurface. The support vectors support the maximal margin hyperplane in the sense that if these log vectors are moved then the maximal margin hypersurface is moved.

FIG. 36B shows an example of a maximal margin hypersurface 3612 separating the log vectors shown in FIG. 36A. The maximal margin hypersurface 3612 is characterized by the classification model / output from the SVM technique 3610. Directional arrows 3614 and 3616 represent margins. Dashed lines 3618 and 3620 are margin boundaries. A margin is the distance from the maximal margin hypersurface 3606 to either of the margin boundaries 3618 and 3620. Support vectors are the log vectors located along the margins closest to the maximal margin hypersurface. Points 3612, 3614, and 3616 located along the margin boundaries 3618 and 3620 are the support vectors in this example. The classification model fis a rule that separates the log vectors represented by open and closed points according to the maximal margin hypersurface.

In one implementation, the SVM technique is used to determine parameters w∈ [symbol] ^{N}^{ₑ} and a constant b∈ [symbol] of a classification model, w^{T}ϕ(L)+b, where ϕ(L)∈ [symbol] ^{N}^{ₑ}, such that the model value given by sign(w^{T}ϕ(L)+b) is correct for most log vectors. The parameters of the classification model are determined by the primal classification problem given by:

$${min}_{w , b , ζ} \frac{1}{2} {w}^{T} w + C {\sum }_{i = 1}^{n} {ζ}_{i} \qquad ( 5 )$$

subject to yᵢ(w^{T}ϕ(L)+b)≥1−ζᵢ, θᵢ≥0, i=1, . . . , n.

Minimizing W^{T}w=∥w∥² maximize the margin (i.e., distance from the maximal margin hypersurface to the margin boundaries) while incurring a penalty when a log vector that is misclassified or within the margin boundary. The value yᵢ(w^{T}ϕ(L)+b) is ideally greater than or equal to 1 for all log vectors. But typical classification problems are not perfectly separable with a maximal margin hypersurface. Some log vectors are permitted to be at a distance ζᵢ from a margin boundary. The penalty term C controls the strength of the penalty and is set by the user. Solving the optimization problem in Equation (5) gives a linear classification model:

fₗ(L)=w^{T}ϕ(L)+b (6)

The numerical method of sub-gradient decent, or coordinate decent, is used to obtain the parameters in Equation (6). The classification model in Equation (6) is a good classification model in the two-class setting where the boundary between the two classes is planar. However, in practice, the boundary between two classes is often not planar and a planar classification model is inadequate.

In an alternative implementation, kernels are used to enlarge the feature space of the log vectors and determine a non-linear classification model that characterizes a non-planar maximal margin hypersurfaces between two classes. Parameters of the non-planar classification model are given by:

$${min}_{α} \frac{1}{2} {α}^{T} Q α - {e}^{T} α \qquad ( 7 )$$

$$subject to {y}^{T} α = 0.0 \leq {α}_{i} \leq C , i = 1 , … , n$$

where e is a vector of all ones, and [symbol] is an n×n positive semidefinite matrix with matrix elements Qᵢⱼ=yᵢyᵢK(Lᵢ, Lⱼ), where K(Lᵢ, Lⱼ)=Δ(Lᵢ)^{T}ϕ(Lⱼ) is the kernel. The terms αᵢ of α are called the dual coefficients that are upper bounded by C. The kernel can be the inner product [symbol] Lᵢ, Lⱼ [symbol] , a polynomial (γ [symbol] Lᵢ, Lⱼ [symbol] +r)^{d}, where γ, d, and r are user specified parameters. radial kernel exp (−γ∥Lᵢ−Lⱼ∥²), and sigmoid tanh(γ [symbol] Lᵢ, Lⱼ [symbol] +r). Solving the optimization problem in Equation (7) gives a non-linear classification model:

$${f}_{n l} ( L ) = {\sum }_{i ∈ SV} {y}_{i} {α}_{i} K ( {L}_{i} , L ) + b \qquad ( 8 )$$

where SV is the set of support vectors.

The numerical method of sub-gradient decent, or coordinate decent, is used to obtain the parameters in Equation (8). Note that the sum in Equation (8) is over the support vectors (i.e. the log vectors that lie within the margin boundaries) because the dual coefficients at are zero for log vectors that are not support vectors.

The classification models obtained in Equations (6) and (8) are binary classifiers that are used to classity a log messages as corresponding to products. If a mapping exists between an application and a product, then the log message of the log vector classified as corresponding to the is assigned to the product. Suppose L denotes a log vector of a log message lm. Let class label y=1 correspond to a first product. Let class label y=−1 correspond to a second product. Let f (L) denote one of the classification models fₗ(L) and fₙₗ(L). When sign(f(L))>0, the log message lm corresponds to the first product. In other words, the log vector L of the log message lm is on the side of a maximal margin hypersurface with log vectors that correspond to the first product. Alternatively, when sign(f(L))<0, the log message lm corresponds to the second product. In other words, the log vector L of the log message lm is on the side of the maximal margin hypersurface with log vectors that correspond to the second product.

The SVM techniques described above are derived for binary classification and do not support classification for more than two classes (i.e., more than two applications). The SVM techniques can be used for multiple classes by splitting the multi-class classification set of log vectors into multiple binary classification sets of log vectors and fit a classification model for each binary classification set. Two different implementations of this approach are the one-versus-one SVM technique and the one-versus-many SVM technique.

The one-versus-many SVM technique splits a multi-class classification problem into one binary classification problem per class (i.e., per application). Where there are K classes, a classification model is trained for each one of the K classes to the remaining K−1 classes. For example, in FIG. 35 there are four classes that correspond to the four products P_1, P_2, P_3, and P_4. The one-versus-many SVM technique trains four classification models for each these classes.

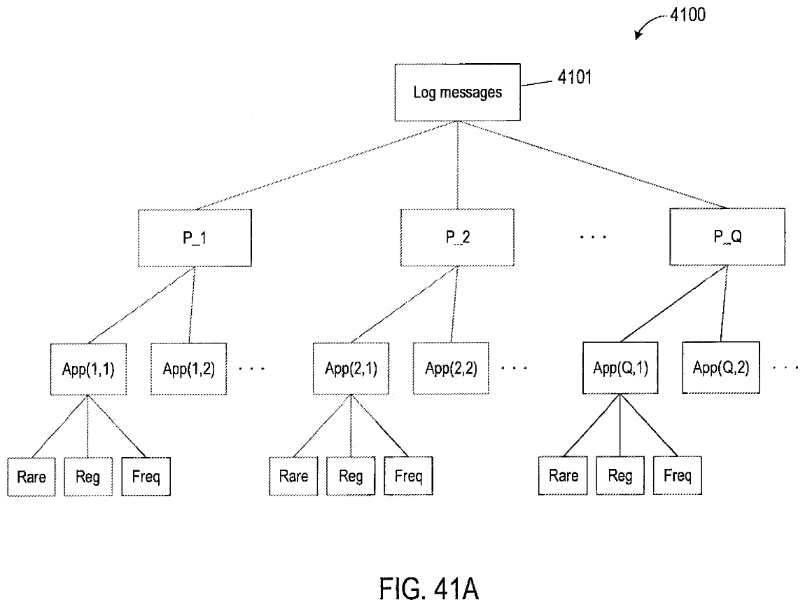

FIGS. 37A-37D show examples of training four classification models denoted by f₁, f₂, f₃, and f₄ that correspond to the four products P_1, P_2, P_3, and P_4. In FIG. 37A, block 3702 represents using the SVM technique to train the classification model f₁ based on a set of log vectors 3704 that correspond to the product P_1 and a set of log vectors 3706 formed from the log vectors that correspond to the products P_2, P_3, and P_4. In FIG. 37B, block 3708 represents using the SVM technique to train the classification model f₂ based on a set of log vectors 3710 that correspond to the product P_2 and a set of log vectors 3712 formed from the log vectors that correspond to the products P_2, P_3, and P_4. FIGS. 37C and 37D similarly represent using the SVM technique to train the classification models f₃ and f₄ for the products P_3, and P_4.

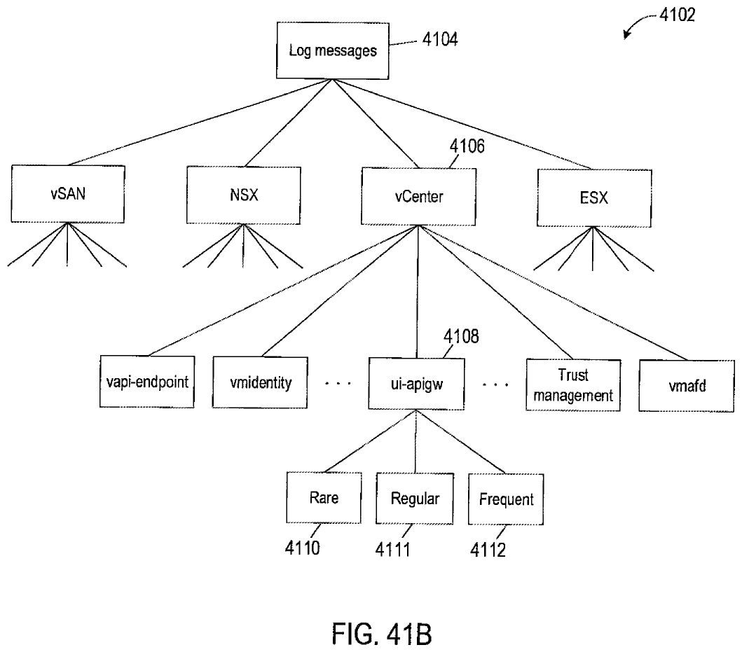

FIGS. 38A-38D show example plots of hypersurfaces that correspond to the trained classification models by f₁, f₂, f₃, and f₄ obtained in corresponding FIGS. 37A-37D. In these examples, the classification models are non-linear classification models that correspond to non-linear hypersurfaces obtained using SVM non-linear classifications. Gray shaded points represent log vectors of combined sets of log messages. For example, in FIG. 38A, solid points correspond to the log vectors of the product P_1 in FIG. 35 and gray shaded points correspond to the log vectors of the products P_2, P_3, and P_4. Curve 3801 represents a non-linear hypersurface that separates the log vectors of the product P_1 from the log vectors of the products P_2, P_3, and P_4 and correspond to the classification model f₂. Similarly, FIGS. 38B-38D show non-linear hypersurfaces 3802-3804 that correspond to the classification models f₂, f₃, and f₄.

Ideally, a log vector L is classified as corresponding to the product with sign(yᵢfᵢ(L))>0, for i=1, 2, 3, 4 and yᵢ is the class label (i.e., yᵢ={−1,1}) of the product. However, in practice it may be the case that two or more classification models are positive for the log vector L. One-to-many SVM technique includes computing a probability score for each of the classes:

$${P}_{i} ( y = 1 \vert L ) = \frac{1}{1 + exp ( {A}_{i} {f}_{i} ( L ) + {B}_{i} )} \qquad ( 9 )$$

The parameters Aᵢ and Bᵢ are scalars that are estimated using a maximum likelihood method that optimizes the same training set of log vectors for the classification model fᵢ. A probability score gives a degree of certainty about a classification model result. Suppose, for example, the log vector L gives sign(y₁f₁(L))>0. sign(y₂f₂(L))<0. sign(y₃f₃(L))<0, and sign(y₄f₄(L))>0. The sign of the classification model alone is not sufficient for classifying the log vector L as corresponding to the product P_1 or the product P_4. In this case, the larger of the corresponding probability scores can be used to classify the log vector. For example, if P₁(y=1|L)>P₄(y=1|L), then the log vector L is classified as corresponding to the product P_1.

The one-versus-one SVM technique splits a multi-class classification into training a different classification model for each pair of classes. Suppose the number of classes M is greater than two. With a one-versus-one, or all-pairs of classes approach, the number of possible combinations of pairs of classes in given by

$$( \begin{matrix}M \\ 2\end{matrix} ) = \frac{M !}{2 ! ( M - 2 ) !}$$

The SVM technique is used to train

$$( \begin{matrix}M \\ 2\end{matrix} )$$

separate classification models. For example, in FIG. 35 the number of classes (i.e., products) is four (i.e., M=4). As a result, there are six pairs of classes. The SVM technique is used to train six classification models. Each classification model corresponds to a pair of products.

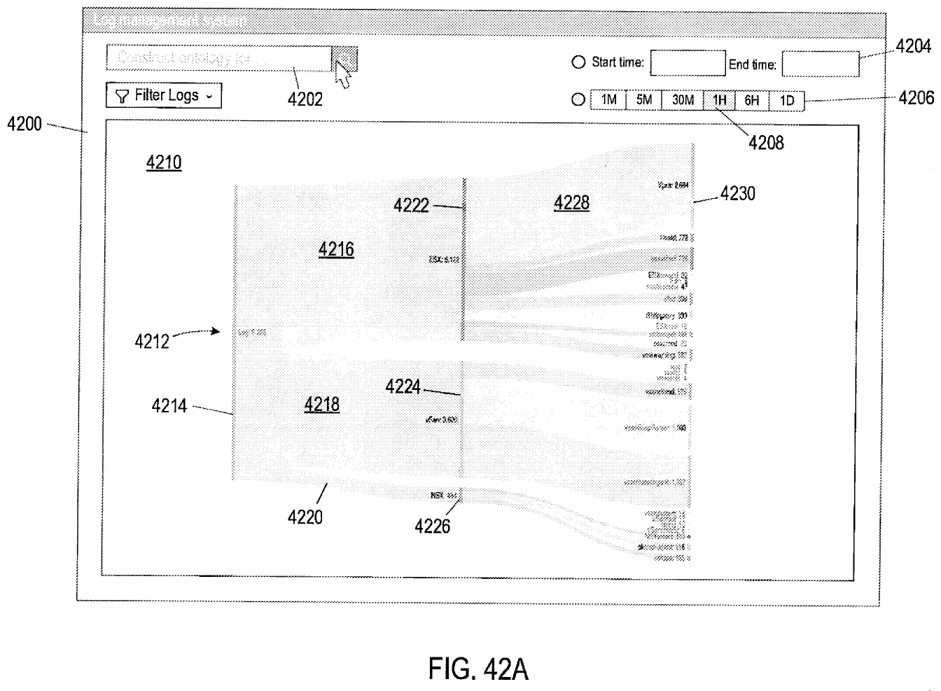

FIGS. 39A-39F show examples of training six classification models for each pair of the six pairs of the four products P_1, P_2, P_3, and P_4. The six resulting classification models are denoted by f_{1,2}, f_{1,3}, f_{1,3}, f_{2,3}, f_{3,4}, and f_{3,4}. In FIG. 39A, block 3902 represents using the SVM technique to train the classification model f_{1,2} based on the set of log vectors 3904 that correspond to the product P_1 and the set of log vectors 3906 that correspond to the product P_2. In FIG. 39B, block 3908 represents using the SVM technique to train the classification model f_{1,3} based on the set of log vectors 3910 that correspond to the product P_1 and the set of log vectors 3912 that correspond to the product P_3. FIGS. 39C-39F similarly represent using the SVM technique to train the corresponding classification models f_{1,4}, f_{2,3}, f_{2,4}, and f_{3,4.}

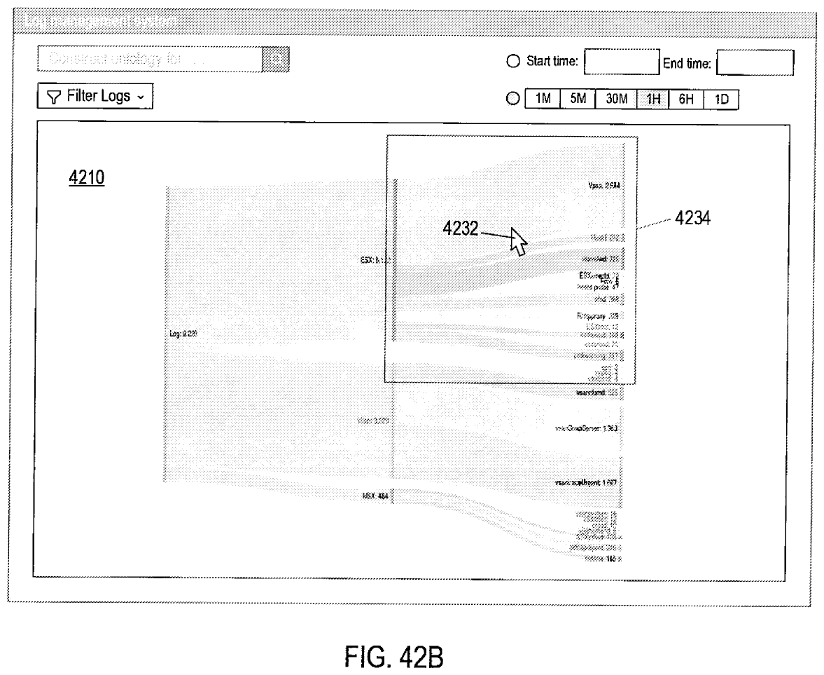

FIGS. 40A-40F show example plots of hypersurfaces that correspond to the trained classification models f_{1,2}, f_{1,3}, f_{1,3}, f_{2,3}, f_{3,4} obtained in corresponding FIGS. 39A-39F. In these examples, the classification models are non-linear classification models that correspond to non-linear hypersurfaces obtained using SVM non-linear classifications. In FIG. 40A, curve 4001 represents a non-linear hypersurface that separates the log vectors of the product P_1 from the log vectors of the product P_2, and corresponds to the classification model f_{1,2}. In FIG. 40B, curve 4002 represents a non-linear hypersurface that separates the log vectors of the product P_1 from the log vectors of the product P_3 and corresponds to the classification model f_{1,3}. Similarly, FIGS. 40B-40F show non-linear hypersurfaces 4003-4006 that correspond to the classification models f_{1,4}, f_{2,3}, f_{2,4}, and f_{3,4.}

Classification a log vector L to a product is accomplished by computing sign (f_{i,j}(L)) for each pair of products P_i and P. j. The log vector L is assigned to one of the two products. For example, if sign (f_{i,j}(L))>0, then log vector L is assigned to the product P_i. On the other hand, if sign (f_{i,j}(L))<0, then log vector L is assigned to the product P_j. The log vector L is classified as corresponding to the product with the largest number of the

$$( \begin{matrix}M \\ 2\end{matrix} )$$

assignments.

The classification models of one-versus-many and one-versus-one SVM techniques can be used to classify log message with an unknown product. For example, the log message is converted to a log vector as described above with reference to block 2209. The classification models are applied to the log vector to identify the corresponding product as described above.

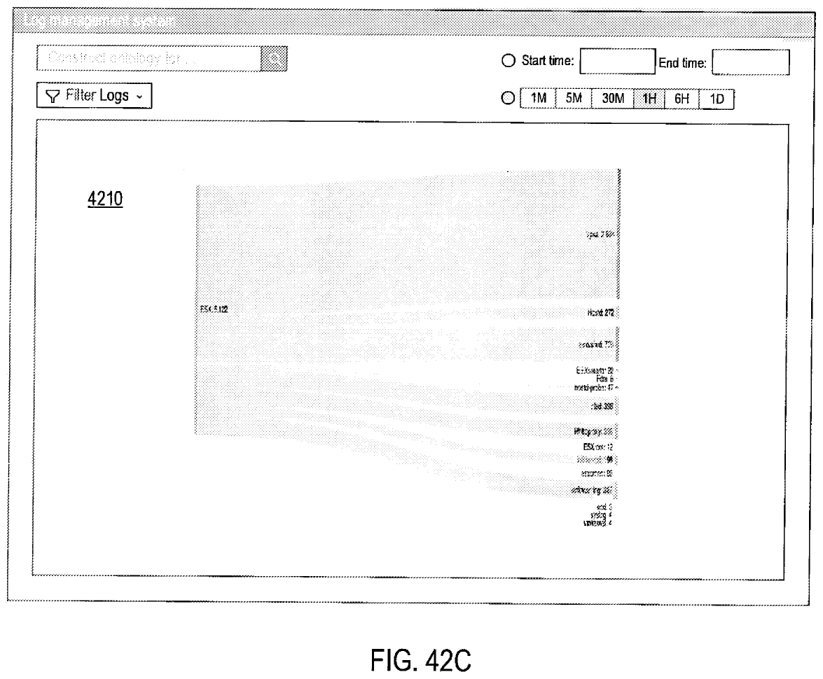

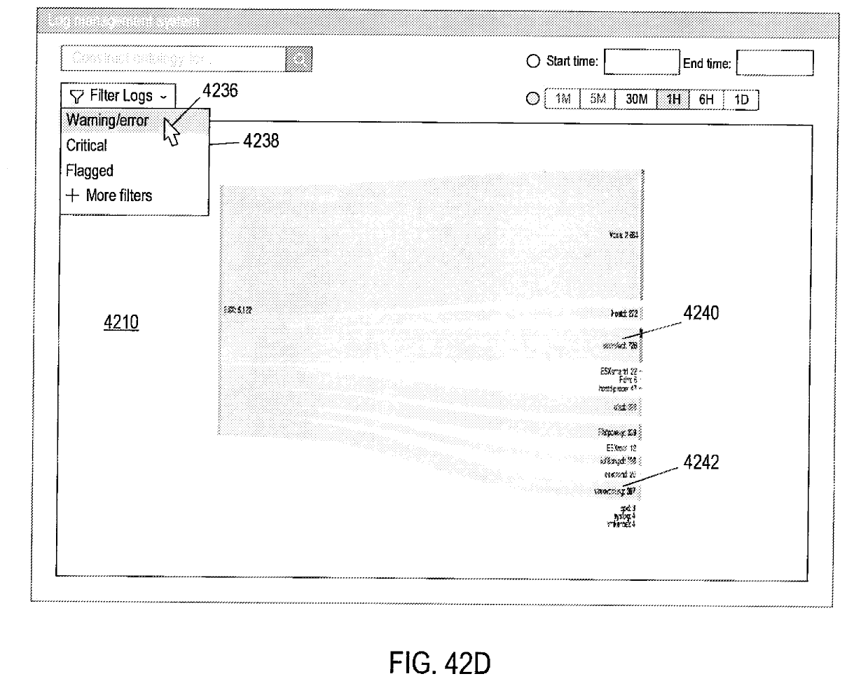

Returning to FIG. 22, in block 2211, a three-tiered ontology of the products, applications, and event types is constructed based on the output from blocks 2206, 2208. and 2210. FIG. 41A shows an example of a general three-tiered ontology 4100 for log messages obtained for a user-selected time frame as represented by block 4101. The first tier contains the products P_1, P 2, . . . P_Q. The second tier contains the applications that run on the platforms provided by the products. For example, the applications App(1,1) and App(1,2) run on the product P_1 and the applications App(2,1) and App(2,2) run on the product P_2. The third tier of the ontology 4100 contains log messages identified as rare, regular, and frequent in accordance with the output from block 2208. The ontology 4100 reveals how the log messages 4101 are distributed across the products, applications, and log messages. For example, certain log messages are associated with the product P_2 and other log messages are distribute across the applications App(2,1). App(2,2), . . . . The log messages associated with the application App(2,1) are rare event types, others are regular event types, and still others are frequent event types.

FIG. 41B show an example of a three-tiered ontology 4102 for log messages associated with VMware products. Block 4104 represents a set of log messages generated in a user selected time frame. The ontology 4102 reveals how these log messages are distributed across products, applications, and event types. For example, a portion of the log messages are associated with the product vCenter represented by block 4106. The log messages associated with the product vCenter are distributed across the applications that run on the platform provided by vCenter. A portion of the log messages associated the vCenter product are associated with the application represented by block 4108, which are further subdivided into rare, regular, and frequent event types as represented by blocks 4110-4112.

The ontology is converted into a flow map that is displayed in a graphical user interface (“GUI”) of display device, such as a monitor or a console. The flow map visually represents of how log messages associated with a system executing in a distributed computing system are distributed across products, applications, and event types for a user-selected time frame. The flow map of the ontology is navigable to enable users at various levels of expertise to visually observe how the log messages are distributed across the various products, applications, and event types. The flow map can be used for resolving performance issues with applications.

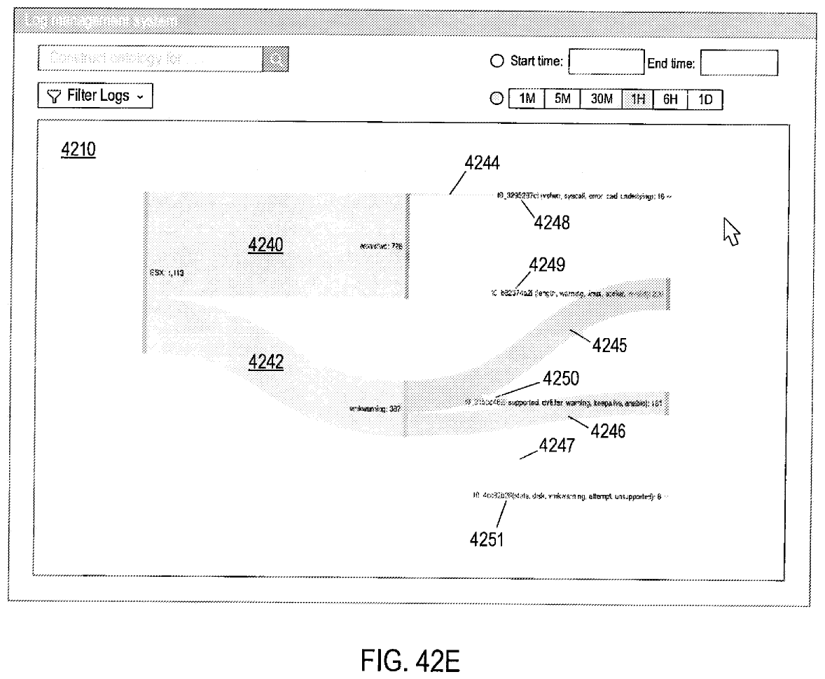

FIGS. 42A-42E show a GUI that displays a navigable flow map that represents an ontology of log messages queried for a user-selected time frame. The GUI 4200 includes a field 4202 for entering the system executing in a data center. The system can be, for example, a VM, a container, a server computer, a cluster of server computers, a distributed application, or an SDDC. The GUI 4200 enable a user to select a time frame for the log messages. For example, the user can input a custom time frame 4204 by entering the start time and end time of the time frame. Alternatively, the user can simply select log messages generated in the last unit of time by click on one of the buttons 4206. In this example, highlighted box 4208 indicates a user selected log messages generated in the last hour.

The GUI 4200 includes a window 4210 that displays a flow map of the log messages generated in the last hour for the system input in the field 4202. The flow map 4210 includes a root that corresponds to the log messages collected in the time frame. The width of the root is proportional to the number of log messages. The flow map branches into products used by the system and branches into applications that run on the platforms provided by the products. The width of each branch is proportional to the number of log messages associated with a product or an application. In this example, the flow map 4210 is displayed horizontally to reveal how the log messages are distributed across products used by the system and how the log messages of each product are distributed across the applications that run on platforms of the products. Vertical line 4214 marks the root of the flow map 4212. The width of the line 4214 is proportional to the number of log messages in the user-selected time frame. In this example, the width of the line 4214 is proportional to 9266 log messages generated in the user-selected time frame. The flow map 4212 branches horizontally into product branches 4216. 4218, and 4220 that reveal how the 9266 log messages are distributed across the products ESX, vSAN, and NXS marked by corresponding vertical lines 4222, 4224, and 4226. The widths of the product branches 4216, 4218, and 4220 are proportional to the numbers of log messages associated with the products. Width of vertical line 4222 is proportional to 5122 log messages that are associated with the product ESX. Width of vertical line 4224 is proportional to 3620 log messages that are associated with the product vSAN. Width of vertical line 4226 is proportional to 484 log messages that are associated with the product NSX. The flow map 4212 also branches horizontally from the products to reveal how the log messages associated the products branch into applications that execute on the platforms provided by the products. Vertical lines, such as vertical line 4230, correspond to the applications that run on the products. The widths of the application branches are proportional to the number of log messages associated with the applications. For example, branch 4228 corresponds to an application Vpax, which is a service agent that executes on the product ESX. Width of the branch 4228 is proportional to 2684 log messages of the 5122 log messages associated with the ESX.

The GUI 4200 enables of a user to select different portions of the flow map for enlargement. In the example of FIG. 42B, the cursor 4232 is placed over the portion of the flow map that corresponds to the ESX product as highlighted by square 4234. Clicking on the flow map within the square 4234 creates a flow map of the ESX product, which is enlarged in the GUI 4200 of FIG. 42C.

The GUI 4200 enables a user to filter the log messages by event type. In FIG. 42D, a user places the cursor 4236 over the filter button to reveal a dropdown menu 4238 of event types. In this example, the user selects event types that include the terms “warning” and “error,” which creates branches of event types that include the terms “warning” and “error.” The event type branches extend from the applications and have widths that are proportional to the number of log messages with the terms “warning” and “error.” In this example, the applications “esxvsfwd” and “vmkwarning” represented by the application branches 4240 and 4242, respectively. have associated log messages with the terms “warning” and “error.” In FIG. 42E, window 4210 displays only the application branches 4240 and 4242 and event branches 4244-4247 that correspond to log messages with the terms “warning” and “error.” The event type branches 4244-4247 are labeled with the corresponding even types 4248-4251 and reveal the terms of the event types. For example, event type 4248 includes the term “error” and event types 4249-4251 include the term “warning.”

The example navigable ontology illustrated in FIGS. 42A-42E is displayed as a flow map in a user interface that enables users at various levels of expertise to detect the log messages and event types that can be used to resolve the performance issues with applications. In the example of FIG. 42E, the log messages of the event types 4248-4251 can be further investigated to detect the reasons for the error and warning messages.

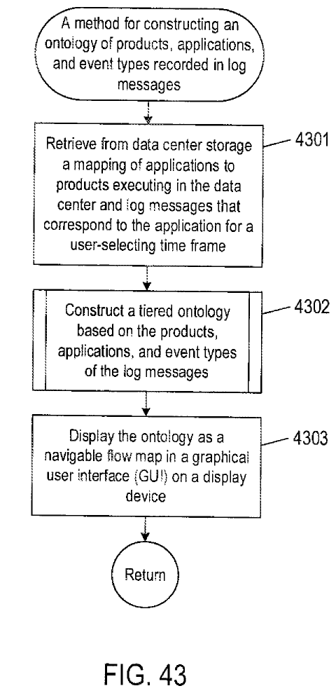

The methods described below with reference to FIGS. 43-48 are stored in one or more data storage devices as machine-readable instructions that when executed by the one or more processors of the computer system shown in FIG. 1 construct a navigable ontology of products, applications, and event types of log messages for a system running in a data center.

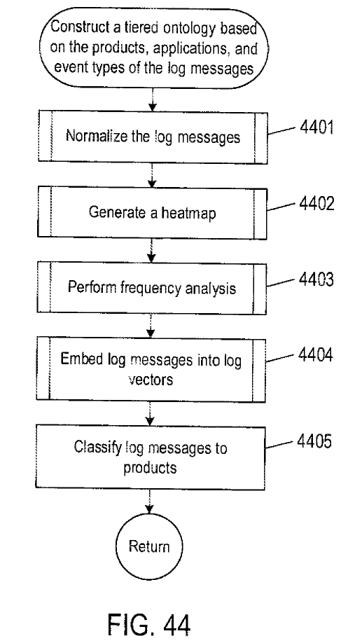

FIG. 43 is a flow diagram of a method for constructing an ontology of products, applications, and events of log messages for a system running in a data center. In block 4301, a mapping of applications to products executing in the data center and log messages that correspond to the applications for a user-selected time frame retrieving from data center storage. In block 4302, a “construct a tiered ontology based on the products, applications, and event types of the log messages” procedure is performed. An example implementation of the “construct a tiered ontology based on the products, applications, and event types of the log messages” procedure is described below with reference to FIG. 44. In block 4303, the ontology is displayed a navigable flow map in a graphical user interface on a display device.

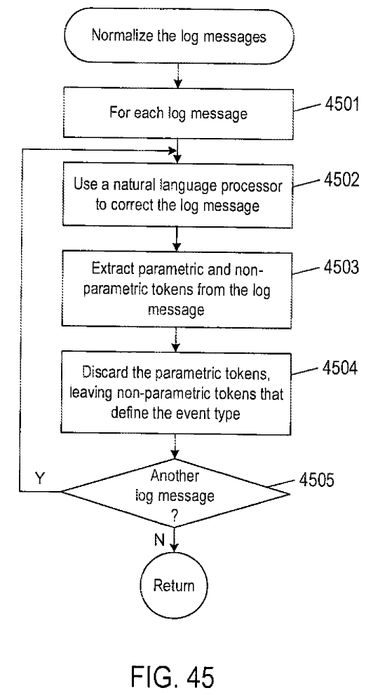

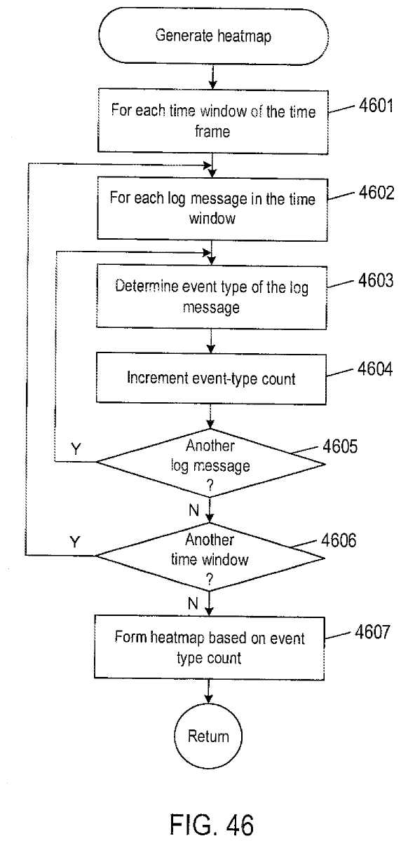

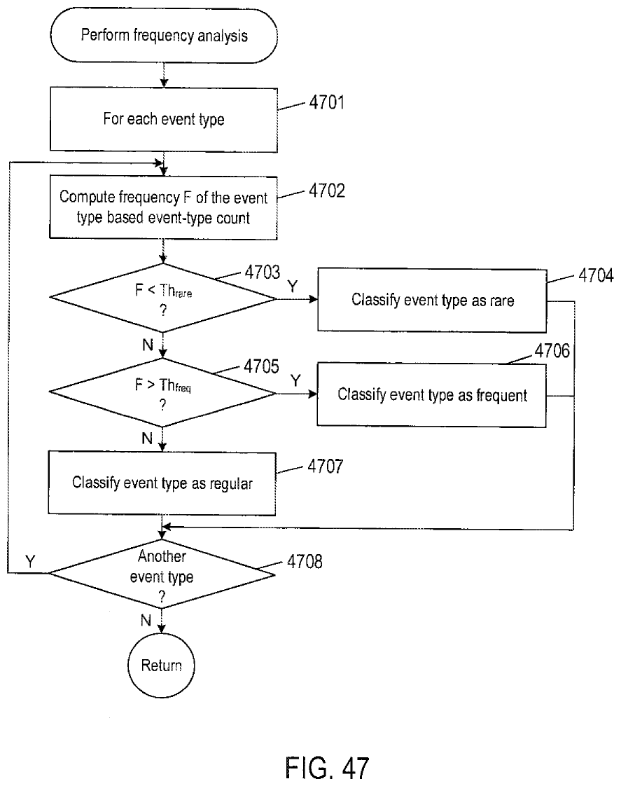

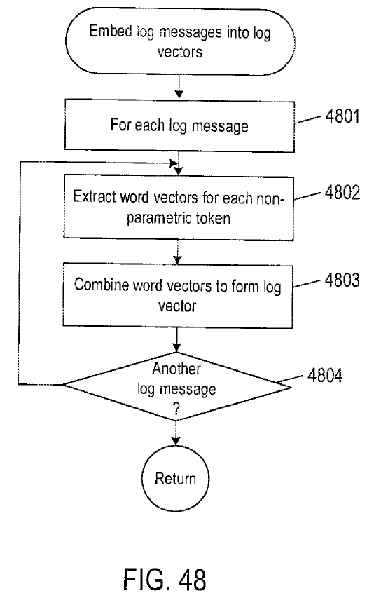

FIG. 44 is a flow diagram illustrating an example implementation of the “construct a tiered ontology based on the products, applications, and event types of the log messages” procedure performed in block 4302 of FIG. 43. In block 4401, a “normalize the log message” procedure is performed. An example implementation of the “normalize the log message” procedure is described below with reference to FIG. 45. In block 4402, a “generate a heatmap” procedure is performed. An example implementation of the “generate a heatmap” procedure is described below with reference to FIG. 46. In block 4403. a “preform frequency analysis” procedure is performed. An example implementation of the “preform frequency analysis” procedure is described below with reference to FIG. 47. In block 4404, a “embed log messages into log vectors” procedure is performed. An example implementation of the “embed log messages into log vectors” procedure is described below with reference to FIG. 48. In block 4405, the log messages are classified to the products using a SVM technique described above.

FIG. 45 is a flow diagram illustrating an example implementation of the “normalize the log message” procedure performed in block 4401 of FIG. 44. A loop beginning with block 4501 repeats the computation operations of blocks 4502-4504 for each log message. In block 4502, a natural language processor is used to correct language, remove punctuation, and stop words from the log message. In block 4503, parametric and non-parametric tokens are extracted from the log message using a regex or a Grok expression. In block 4504, the parametric tokens are discarded, leaving non-parametric tokens that define the event type as described above. In decision block 4505, blocks 4502-4504 are repeated for another log message.

FIG. 46 is a flow diagram illustrating an example implementation of the “generate a heatmap” procedure performed in block 4402 of FIG. 44. A loop beginning with block 4601 repeats the computation operations of blocks 4602-4604 for each time window of the time frame. A loop beginning with block 4602 repeats the computation operations of blocks 4603-4604 for each log message recorded in the time window. In block 4603, event type of the log message is determined as described above with reference to FIGS. 24 and 26. In block 4604, an event-type count is incremented as described above with reference to FIG. 27. In decision block 4505, blocks 4603 and 4604 are repeated for another log message. In decision block 4505, blocks 4602-4605 are repeated for another time window. In block 4607, a heatmap is formed from the event-type counts as described above with reference to FIGS. 28-30.

FIG. 47 is a flow diagram illustrating an example implementation of the “preform frequency analysis” procedure performed in block 4403 of FIG. 44. A loop beginning with block 4701 repeats the computation operations of blocks 4702-4707 for each event type. In block 4702, a frequency is computed as described above with reference to Equation (1). In decision block 4703, when the frequency is less than a rare occurrence threshold, control flows to block 4704 in which the event type is classified as rare. In decision block 4705, when the frequency is greater than a frequent occurrence threshold, control flows to block 4706 in which the event type is classified as frequent. In block 4707, the event type is classified as regular. In decision block 4708, blocks 4702-4707 are repeated for another event type.

FIG. 48 is a flow diagram illustrating an example implementation of the “embed log messages into log vectors” procedure performed in block 4404 of FIG. 44. A loop beginning with block 4801 repeats the computation operations of blocks 4802-4803 for each log message. In block 4802, word vectors are extracted from a domain specific embedding of a natural language process for non-parametric tokens of the log message. In block 4803, the word vectors are combined to obtain a log vector as described above with reference to Equation (4). In decision block 4804, blocks 4802 and 4803 are repeated for another log message.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer-implemented method for constructing a navigable ontology of products. applications, and event types of log messages associated with a system running in a data center, the method comprising:
retrieving from data storage a mapping of applications to products executing in the data center and log messages that correspond to the applications for a user-selected time frame;
constructing a tiered ontology based on the products, applications, and event types of the log messages, the ontology representing how the log messages are distributed across the products, applications, and event types: and
displaying the ontology as a navigable flow map in a graphical user interface (“GUI”) on a display device, the flow map visually representing a distribution of the log messages across products and applications and enabling a user to select particular event types of the log messages for visual inspection.

2. The method of claim I wherein constructing the tiered ontology comprises:
using regular expressions to extract parametric and non-parametric tokens from the log messages; and
discarding the parametric token to obtain non-parametric tokens that reveal the event types of the log messages.

3. The method of claim 1 wherein constructing the tiered ontology comprises:
generating a heatmap of the event types of the log messages recorded in time windows of the user-selected time frame; and
classifying the event types as rare, regular, and frequent based on the heatmap.

4. The method of claim 1 wherein constructing the tiered ontology comprises:
for each log message.
embedding non-parametric tokens of the log message into a word vectors, and
combining the word vectors to form a log vector that represents the log message in an embedding space:
using support vector machines to create classification models that classify the log vectors as corresponding to the products; and
applying the classification models to the log vectors to classify the corresponding log message as corresponding to the products.

5. The method of claim 1 wherein enabling the user to select particular event types of the log messages for visual inspection comprises filtering event types for non-parametric selected via the GUI.

6. A computer system constructing a navigable ontology of products, applications, and event types of log messages associated with a system running in a data center, the system comprising:
one or more processors;
one or more data storage devices; and
machine-readable instructions stored in the one or more data storage devices of the computer system that when executed using the one or more processors controls the computer system to perform operations comprising:
retrieving from the one or more data storage devices a mapping of applications to products executing in the data center and log messages that correspond to the applications for a user-selected time frame:
constructing a tiered ontology based on the products, applications, and event types of the log messages, the ontology representing how the log messages are distributed across the products, applications, and event types: and
displaying the ontology as a navigable flow map in a graphical user interface (“GUI”) of a display device, the flow map visually representing a distribution of the log messages across products and applications and enabling a user to select particular event types of the log messages for visual inspection.

7. The system of claim 6 wherein constructing the tiered ontology comprises:
using regular expressions to extract parametric and non-parametric tokens from the log messages; and
discarding the parametric token to obtain non-parametric tokens that reveal the event types of the log messages.

8. The system of claim 6 wherein constructing the tiered ontology comprises: generating a heatmap of the event types of the log messages recorded in time windows of the user-selected time frame; and
classifying the event types as rare, regular, and frequent based on the heatmap.

9. The system of claim 6 wherein constructing the tiered ontology comprises:
for each log message,
embedding non-parametric tokens of the log message into a word vectors, and
combining the word vectors to form a log vector that represents the log message in an embedding space:
using support vector machines to create classification models that classify the log vectors as corresponding to the products; and
applying the classification models to the log vectors to classify the corresponding log message as corresponding to the products.

10. The system of claim 6 wherein enabling the user to select particular event types of the log messages for visual inspection comprises filtering event types for non-parametric selected via the GUI.

11. A non-transitory computer-readable medium encoded with machine-readable instructions for enabling one or more processors of a computer system to . . . in a data center by performing operations comprising:
retrieving from data storage a mapping of applications to products executing in the data center and log messages that correspond to the applications for a user-selected time frame;
constructing a tiered ontology based on the products, applications, and event types of the log messages, the ontology representing how the log messages are distributed across the products, applications, and event types; and
displaying the ontology as a navigable flow map in a graphical user interface (“GUI”) of a display device, the flow map visually representing a distribution of the log messages across products and applications and enabling a user to select particular event types of the log messages for visual inspection.

12. The medium of claim 11 wherein constructing the tiered ontology comprises:
using regular expressions to extract parametric and non-parametric tokens from the log messages; and
discarding the parametric token to obtain non-parametric tokens that reveal the event types of the log messages.

13. The medium of claim 11 wherein constructing the tiered ontology comprises:
generating a heatmap of the event types of the log messages recorded in time windows of the user-selected time frame; and
classifying the event types as rare. regular, and frequent based on the heatmap.

14. The medium of claim 11 wherein constructing the tiered ontology comprises:
for each log message,
embedding non-parametric tokens of the log message into a word vectors, and
combining the word vectors to form a log vector that represents the log message in an embedding space:
using support vector machines to create classification models that classify the log vectors as corresponding to the products; and
applying the classification models to the log vectors to classify the corresponding log message as corresponding to the products.

15. The medium of claim II wherein enabling the user to select particular event types of the log messages for visual inspection comprises filtering event types for non-parametric selected via the GUI.
